(19) United States
(12) Patent Application Publication
(10) Pub. No.: US 2024/0053973 A1
(43) Pub. Date: Feb. 15, 2024

(54) DEPLOYABLE CONTAINER SCHEDULING AND EXECUTION ON CLOUD DEVELOPMENT ENVIRONMENT

(71) Applicant: Intel Corporation, Santa Clara, CA (US)

(72) Inventors: Vidya Ranganathan, Bangalore (IN); Aditya Shukla, Bangalore (IN); Nitesh Kumar, Bangalore (IN); Jitendra Kumar Saini, Alwar (IN)

(21) Appl. No.: 17/972,378

(22) Filed: Oct. 24, 2022

(51) Int. Cl. G06F 8/61; G06F 9/445; G06F 21/57

(52) U.S. Cl. CPC G06F 8/63; G06F 9/44505; G06F 21/577

(57) ABSTRACT

Various systems and methods are described for deployment, import, and scheduling of containers and other software components on cloud and edge computing hardware. A development platform may receive, from a remote location, package data for a deployment of one or more containers, including a configuration for the one or more containers. Such package data may be provided by a Helm chart or a Docker Compose YAML file. The development platform may extract the configuration for the one or more containers from the package data, and also perform a security evaluation of the one or more containers and the configuration for the one or more containers to validate compliance with a security policy. The development platform may execute (and coordinate scheduling) of one or more container images for the one or more containers, based on the configuration, after validating compliance with the security policy.

### TECHNICAL FIELD

Embodiments described herein generally relate to data processing in networked computing environments, and in particular, to the use of computing technologies for testing, building, and deployment of containers and other software components on cloud and edge computing hardware.

### BACKGROUND

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an import of a Helm Chart into a cloud development environment, according to an example;

FIG. 2 depicts an overall end-to-end workflow of importing and using a Helm Chart in a cloud development environment, according to an example;

FIG. 3 depicts an import of Docker Compose YAML data into a cloud development environment, according to an example;

FIG. 4 depicts a flow for availability of container images in a cloud development environment, according to an example;

FIG. 5 depicts an end-to-end flow of a Docker Compose import with synchronous execution of builds, according to an example;

FIG. 6 depicts an end-to-end flow of a Docker Compose import with asynchronous execution of builds, according to an example;

FIG. 7 depicts a topology of edge nodes for a cloud development environment, according to an example;

FIG. 8 depicts a scheduling framework for a Container First Architecture deployment, according to an example;

FIG. 9 depicts an end-to-end workflow of scheduling in a Container First Architecture deployment, according to an example;

FIG. 10 illustrates a flowchart of a method for processing of container software package images, encompassing the import and scheduling techniques provided among FIGS. 1 to 9, according to an example;

FIG. 11 illustrates an overview of an edge cloud configuration for edge computing, according to an example;

FIG. 12 illustrates deployment and orchestration for virtual edge configurations across an edge-computing system operated among multiple edge nodes and multiple tenants, according to an example;

FIG. 13 illustrates a vehicle compute and communication use case involving mobile access to applications in an edge-computing system, according to an example;

FIG. 14 illustrates a block diagram depicting deployment and communications among several Internet of Things (IoT) devices, according to an example;

FIG. 15 illustrates an overview of layers of distributed compute deployed among an edge computing system, according to an example;

FIG. 16 illustrates an overview of example components deployed at a compute node system, according to an example;

FIG. 17 illustrates a further overview of example components within a computing device, according to an example; and

FIG. 18 illustrates a software distribution platform to distribute software instructions and derivatives, according to an example.

### DETAILED DESCRIPTION

In the following description, methods, configurations, and related apparatuses are disclosed for import and deployment of containers on the edge for variants of hardware, and for the scheduling of the use of such containers on variants of hardware in a development architecture. Such variants of hardware may be provided by (but are not limited to) a deployment architecture such as the Intel® DevCloud platform, which allows an end-user to actively prototype and experiment with workloads (e.g., AI workflows for computer vision, networking applications for 5G, etc.) on different types of edge/cloud hardware. DevCloud, as referenced herein, is an example of a Container First Architecture (CFA) also known as Container Playground (CP), which is an architecture operating in a private cloud that allows end-users to bring in one or multiple containers in iterative fashion for execution of the workloads on Edge nodes.

In a first example, techniques are described for allowing end-users to import Helm Chart data with workload execution, on a development edge node across various hardware processors and accelerators of the deployment architecture. In particular, a framework is configured to enable portable deployment of industry standard Helm Charts, on the fly, to leverage the capabilities of Deep Learning (and, non-Deep Learning) solutions on underlying hardware.

In a second example, techniques are described for allowing end-users to import and deploy Docker Compose data, on a development edge node across various hardware processors and accelerators. In particular, a framework is configured to enable end-user import of Docker Compose YAML with Deep Learning based workload execution on the edge node across various hardware processors and accelerators of the deployment architecture. This enables portable deployment of industry standard Docker Compose YAML files on the fly, to also leverage the capabilities of Deep Learning or non-Deep Learning solutions on underlying hardware.

In a third example, techniques are disclosed for an optimized and efficient scheduling framework for container orchestration in edge nodes of a deployment architecture. This enables an optimized self-efficient, easily tunable scheduling framework for execution and container orchestration on the edge across various classes of hardware and accelerators.

The Container First Architecture (CFA) discussed herein enables end-users to deploy one or multiple containers for Deep Learning inference into a private cloud (e.g., hosted by an OEM) to test and run the workload on the edge nodes. A CFA is designed to help developers learn how to implement deep-learning applications, with containers, to enable compelling, high-performance solutions with containerized deployments.

Import and Deployment of Helm Charts on the Edge for Variants of Hardware

A first implementation example of the CFA deployment model enables end-users to bring in Helm Charts for Deep Learning inference into a private development cloud (e.g., hosted by an OEM), to run one or more workloads on the edge nodes. One of the important challenges handled by a CFA deployment model includes addressing a variety of security and safety measures during the import of Helm Chart data, because a vulnerable container can harm the host machine.

Current cloud vendors do not enable the import of Helm Charts from end-users for AI or Deep Learning models. This hinders heterogeneity for migration of containerized workloads across the cloud. As a result of this, the end-users will have to re-build containers every time they wish to deploy the containers on cloud or edge nodes. A Helm Chart provides a common mechanism to package the container images and import them into an environment.

In a CFA deployment discussed herein, end-users (e.g., customers) can bring packaged software for deployments on the edge. The following use of Helm Charts provides a mechanism to deploy, text, and operate container images. To handle security concerns with container images within the Helm Chart, security integrity validation of the container images is performed by scanning the same in addition to privilege management for the given persona or entitlement.

The following approaches are usable in combination with a OpenVINO toolkit (bridge) by enabling inference on the edge with container deployments. As noted, there are no cloud vendors or competitors today who enable end-users to bring in Helm Charts onto edge nodes across multiple hardware accelerators. Among others, the following deployments are applicable to many types of Deep Learning platforms and frameworks, including TensorFlow, PyTorch, ONNX, Caffe2, CAL D, and MXNet supported by OpenVINO.

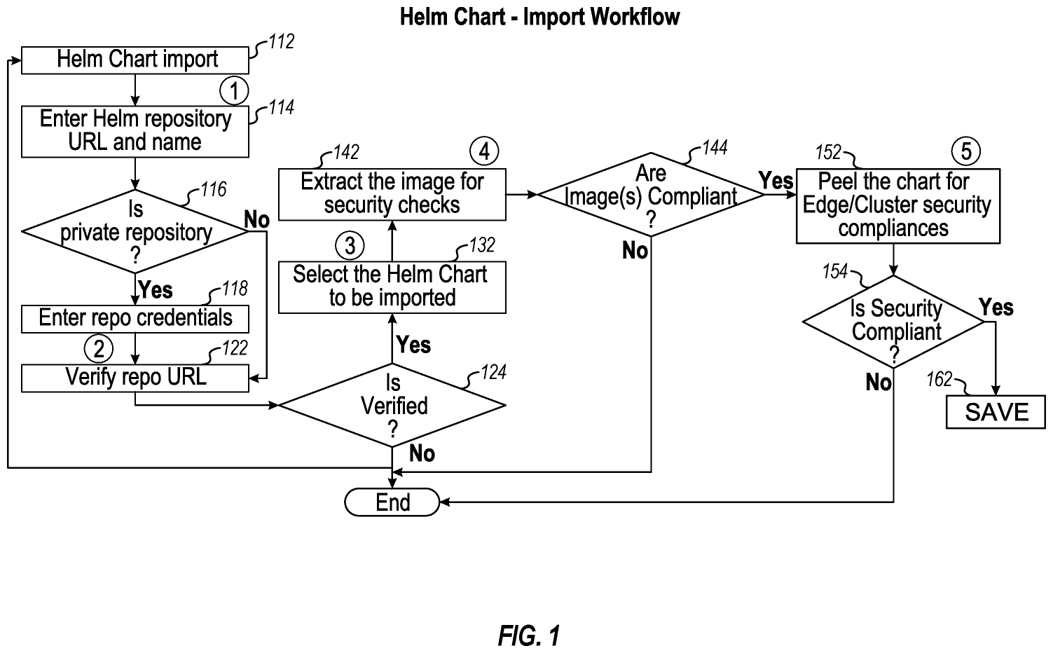

The End-to-End architecture of a CFA can be modified to support “Bring Your Own Helm Chart” capabilities, according to the following approaches. FIG. 1 depicts an import of a Helm Chart into a cloud development environment. The stages for import of Helm Chart in this depiction are discussed below.

At a first stage (corresponding to Stage #1 circled in FIG. 1), a Helm chart is imported (e.g., at 112) by downloading the Helm Chart, such as is accessed from an entered Helm repository (e.g., at 114) using a load API. The Helm Chart is then parsed at subsequent steps discussed below. In case of retrieval from a private repository (e.g., at 116), the repository credentials (such as username and token, e.g., at 118) are entered and used to pull (e.g., access and retrieve) the Helm Chart from the repository. In an example, the end-user is allowed to provide his/her own name to the Helm repository that is to be downloaded on to the development environment.

At a second stage (corresponding to Stage #2 circled in FIG. 1), based on the download status of the Helm repository, the verification of the Helm repository URL occurs (e.g., at 122). Here, retrieving valid Helm Charts present in the Helm repository is referred to as “verification” (e.g., at 124). If not successfully verified, meaning there are no Helm Charts present in the repository, the workflow returns to the first stage.

At a third stage (corresponding to Stage #3 circled in FIG. 1), upon successful verification of the Helm repository (e.g., at 124), the valid Helm Charts are retrieved. The end-user can choose from the list of charts which were retrieved (e.g., at 132) and select one or more charts for importing into the container deployment platform (e.g., at 132).

At a fourth stage (corresponding to Stage #4 circled in FIG. 1), based on the selected chart, a Helm Chart inspector is used to extract the image and perform security checks (e.g., at 142). The security checks may include initially checking for syntax. In an example, if the syntax is wrong for any Helm resource, the context will return to the first stage (e.g., at 144). Upon the successful inspection result from Helm Chart inspector, the Helm Chart custom parser will list out all the container images that are used by the Helm resources. The images are then scanned asynchronously for potential malware or any other security vulnerability.

At a fifth stage (corresponding to Stage #5 circled in FIG. 1), upon successful result from the Helm Chart inspector for syntax (e.g., verified at 144), additional data from the Helm Chart will be extracted, i.e., Helm Chart will be “peeled” for security compliance with individual resources (e.g., at 152). Once the resources are peeled, they are converted to resource objects. Then the Helm Chart Inspector parses through every resource object, to check for edge and cluster security compliances (e.g., verified at 154). If the resource objects are security compliant, the property values are overridden or removed according to the rules and policies set in the Helm Chart inspector. In an example, the end-user is given an option to verify the properties that are overridden by presenting the original Helm Chart properties and the revised Helm Chart properties.

Finally, upon successful verification from the end-user, the Helm Chart inspector checks for asynchronous image inspection results. If the image inspection is successful, then container image from the Helm Chart is saved and is successfully imported into the CFA environment (e.g., at 162). If the image inspection is unsuccessful, then the workflow terminates.

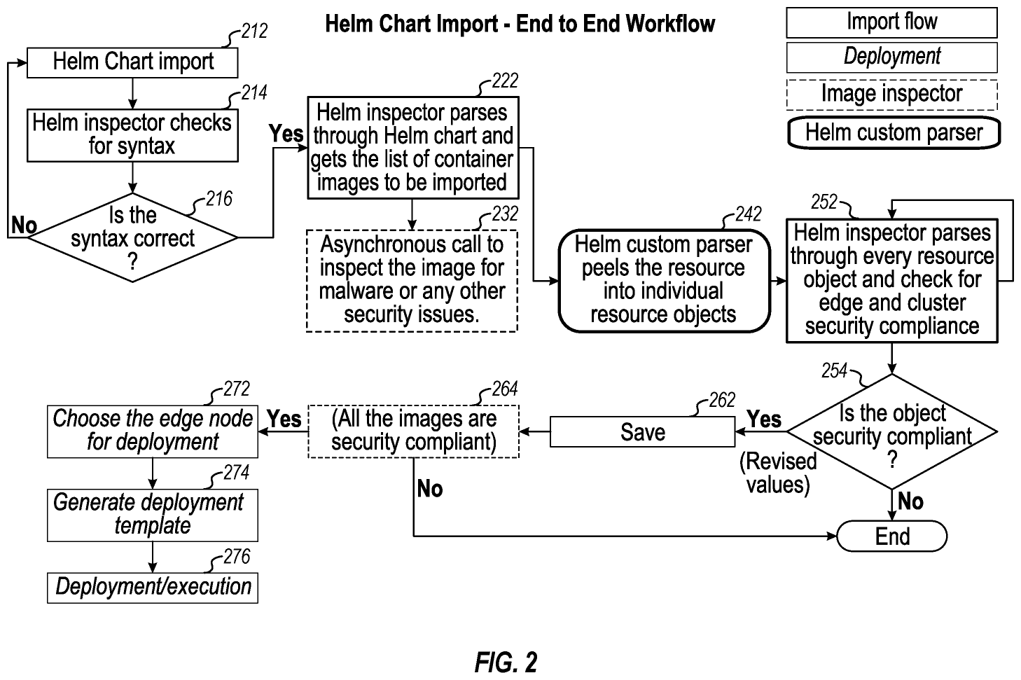

FIG. 2 depicts an overall end-to-end workflow of import and use of the Helm Chart in a cloud development environment. Here, this workflow depicts additional operations performed by components used for import and security checking including the Helm inspector, Image inspector, and Helm custom parser.

First, the Helm Chart is imported (e.g., at 212), and the Helm inspector checks the Helm Chart for syntax (e.g., at 214). If the syntax is incorrect (e.g., at 216), then the import fails and returns to the import start. If the syntax is correct, then the Helm inspector parses through the Helm chart, and identifies a list of container images to be imported (e.g., at 222).

The Helm inspector makes an asynchronous call to an Image inspector to inspect the container image for malware or any other security issues (e.g., at 232). Additionally, the Helm custom parser peels the resource (from the container image) into individual resource objects (e.g., at 242). The Helm inspector parses through every resource object and checks for edge and cluster security compliance (e.g., at 252). If any of the resource objects are not security compliant (e.g., at 254), then the resource object is not saved and the workflow terminates. If the resource object is security compliant (e.g., at 254), then the object is saved, and further processing is continued for remaining resource objects.

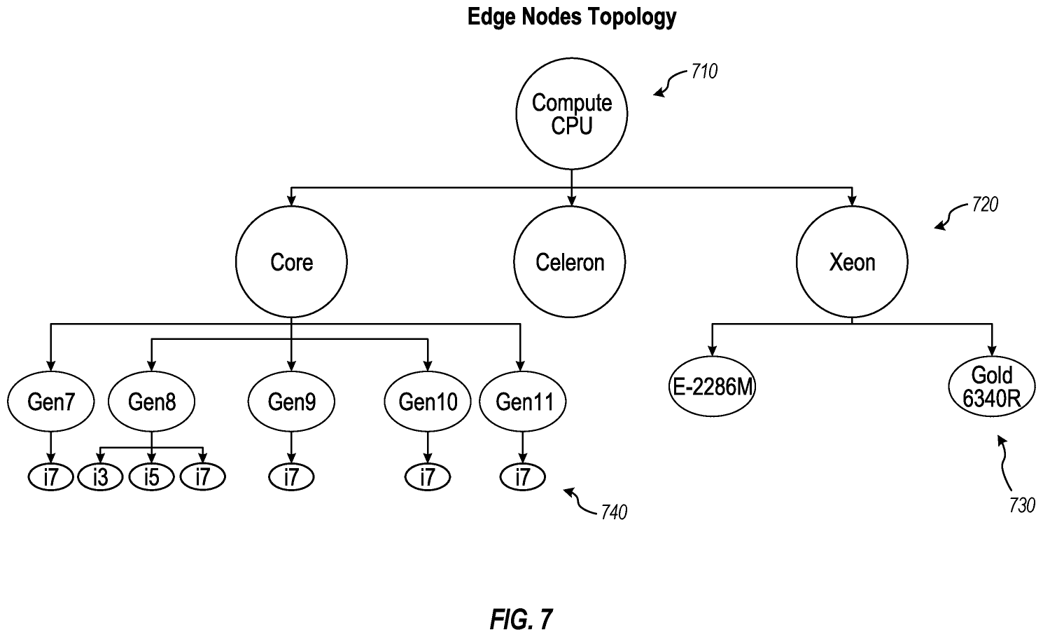

Finally, if all of the container images are security compliant (e.g., at 264), then the container images can be enabled for deployment. This may include, choosing the edge node for deployment (e.g., at 272), generating a deployment template (e.g., at 274), and ultimately the deployment and execution of the container image (e.g., at 276). More details on deployment and scheduling are discussed with reference to FIGS. 7 to 9, below.

Import and Deployment of Docker Compose Components on the Edge for Variants of Hardware

The following also describes a similar CFA deployment model to enable end-users to bring in Docker Compose YAML files from repositories for execution of the containers and associated workloads on the edge nodes. In particular, this CFA configuration addresses a variety of security and safety measures during the import of Docker Compose YAML data, because a vulnerable container can harm the host machine.

Current cloud vendors do not enable the import of Docker Compose YAML from end-users for AI or Deep Learning models. This hinders heterogeneity for migration of containerized workloads across the cloud. As a result of this, the end-users will have to re-build containers every time they wish to deploy on cloud or edge nodes. Like a Helm chart, a Docker Compose YAML file provides a common mechanism to package the container images and import them into an environment.

In the CFA architecture discussed herein, end-users (e.g., customers) can bring packaged software for deployments on the edge. The following use of Docker Compose YAML imports provides a mechanism to deploy, text, and operate container images. To handle security concerns with container images within the Docker Compose YAML, security integrity validation of the container images is performed by scanning the same in addition to privilege management for the given persona or entitlement.

The following approaches are usable in combination with a OpenVINO toolkit (bridge) by enabling inference on the edge with container deployments. As noted, there are no cloud vendors or competitors today who enable end-users to bring in Docker Compose YAML onto edge nodes across multiple hardware accelerators. Among others, the following deployments are applicable to many types of Deep Learning platforms and frameworks, including TensorFlow, PyTorch, ONNX, Caffe2, CAL D, and MXNet supported by OpenVINO.

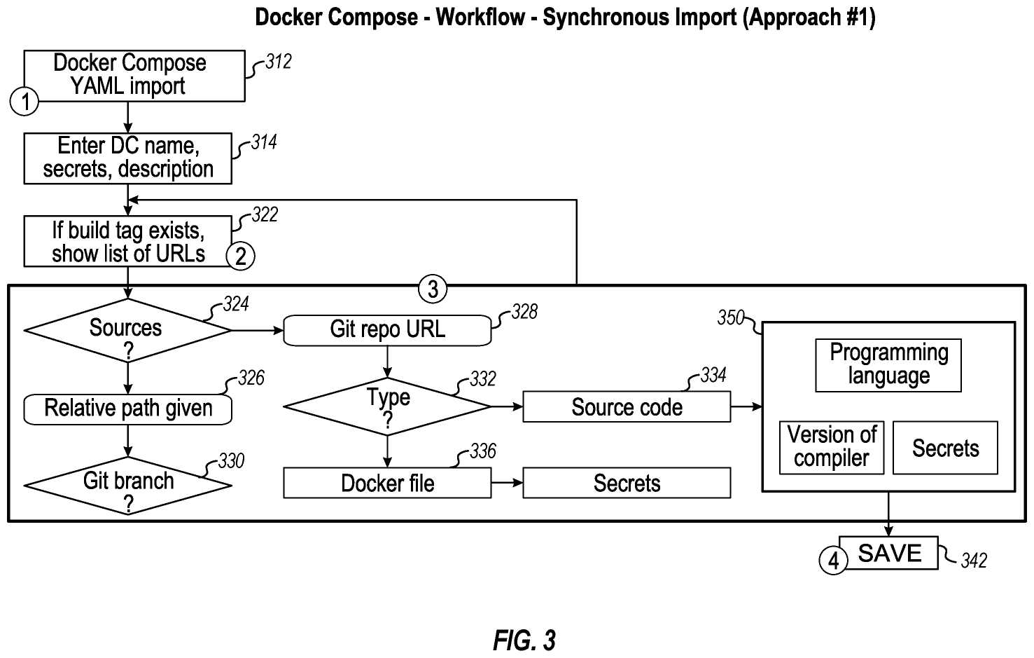

The End-to-End architecture of a CFA can be modified to support “Bring Your Own Docker Compose YAML” capabilities, according to the following approaches. FIG. 3 depicts an import of a Docker Compose YAML into a cloud development environment. The stages for synchronous import of Docker Compose YAML is discussed below.

At a first stage (corresponding to Stage #1 labeled in FIG. 3), the YAML data is downloaded (e.g., at 312) with a load API and parsing of the YAML file (e.g., based on information entered at 314). The container images are also peeled from the information indicated in the Docker Compose YAML. In this context, peeling means fetching the pre-built container images along with its location. Whether peeling or parsing, there can be nested builds with Dockerfile(s) which are also pulled out. In this context, parsing also refers to search. For instance, this may include searching if a “build” tag(s) exists and extracting all of the Git repository URLs.

At a second stage (corresponding to Stage #2 labeled in FIG. 3), based on the parsing results, a “List” is generated to show all URLs of Git repositories (e.g., at 322). For example, this list may be shown on a dashboard, and an end-user can pick the URL from the “List” one by one and define pre-requisites.

At a third stage (corresponding to Stage #3 labeled in FIG. 3), the next task is to iterate sources for every URL (e.g., at 324), such as for every Git repository URL (e.g., at 328). There can be various types of build requests coming from a Docker Compose YAML file. Three types are as shown in FIG. 3. The request can come from a “relative path” to a source code location in the URL (e.g., at 326), a Dockerfile to be generated, or a Git repository URL comprising of either source code (e.g., at 334) or again a Dockerfile itself (e.g., at 336).

If the Git repository has sources with source code (e.g., at 334), then information such as the programming language (PL) and version of compiler to build the source code with has to be sought from the end-user (e.g., 350). Here, it is necessary that the end-user is asked for choice of PL and version. Alternatively, intelligence from the framework shall also be able to automatically detect the type of PL and build on latest version of compiler. If the Git repository is only pointing to a Docker file (e.g., at 336), then the framework does not need to seek anything but can proceed with the build. If the source is a relative path (e.g., at 326), then the framework can use a branch (e.g., at 330). If a branch is not provided then the default may be a master branch.

In an example where the build tag has no entry of a Docker file, but only has a command for invocation, then a build is kicked off with an entry point. Additionally, the block for build tag can be extracted for details on the git repository based on offset across YAML and saved into database as appropriate for further use. It will be understood that any of these operations may be performed separately (one by one) or all at once if the PL and version is same.

At a fourth stage (corresponding to Stage #4 labeled in FIG. 3), on save (e.g., at 342), the build tag blocks are extracted and saved to the deployment environment, and may be visible in an imported panel of the dashboard. If no build tags exist, the container details may be peeled out of YAML in the import panel. If build tags exist, then the Git repository URLs may be shown on the dashboard until build is ready. (Once the Docker compose YAML is imported, the container images and the Git repository URL entries are placed in the dashboard of the deployment environment.)

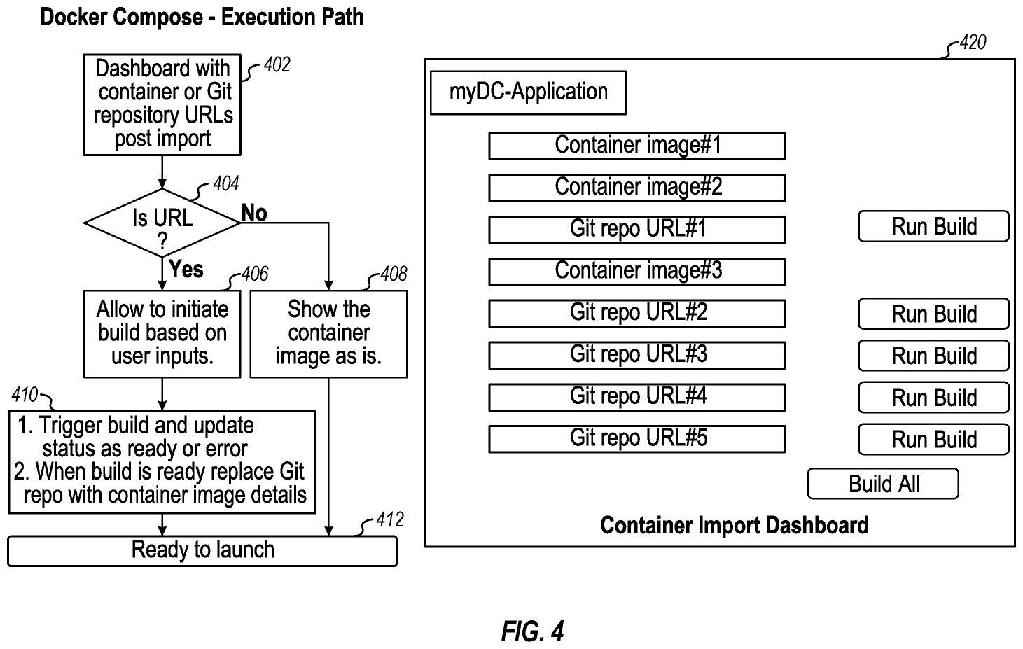

FIG. 4 depicts a flow for availability of container images in a cloud development environment, in which the container images can be made available for deployment prior to launch. The right-hand side of FIG. 4 (dashboard 420) shows an import of Docker Compose YAML peeled across pre-built containers images, and Git repository URLs for obtaining source code that has not been built yet. The left side shows a flow of presenting, in the dashboard, container image information or Git repository URLs (e.g., at 402).

For the sources that provide unbuilt code (e.g., code from a URL at 404), the dashboard 420 includes a user-selectable option such as “Run build′ that enables the end-user to start a build manually (e.g., at 406 and 410). There may also be a “Build All” option as well an option for instantiating “N” simultaneous builds (e.g., 3 simultaneous builds). If the code is already built, the dashboard presents information on the built container image (e.g., at 408). When all the container images with the corresponding data are complete, the Docker Container import is ready to launch (e.g., at 412).

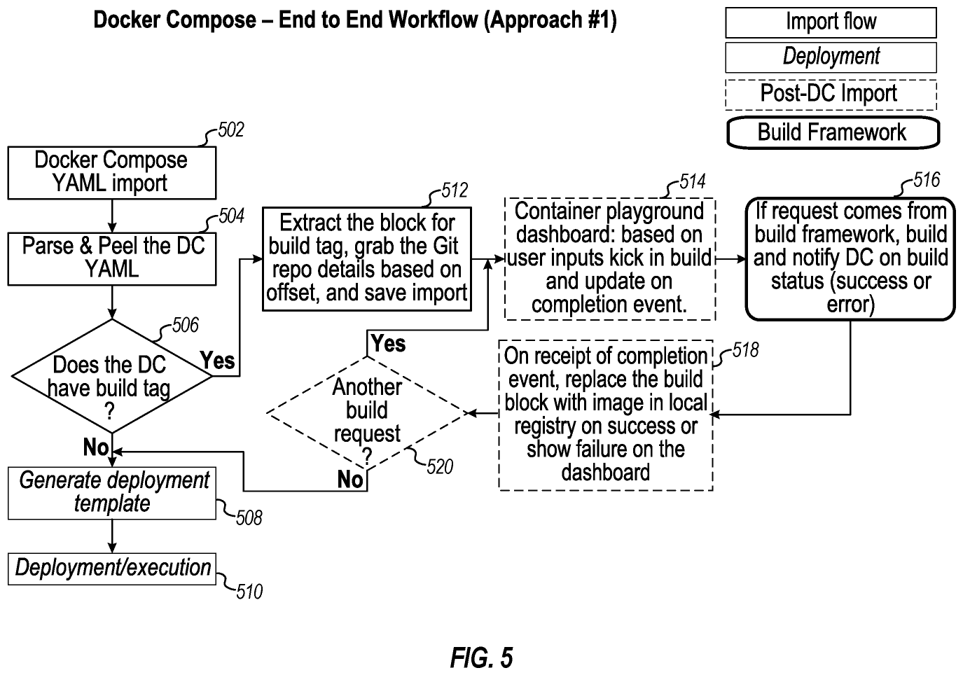

FIG. 5 depicts an overall end-to-end workflow of the Docker Compose import with synchronous or serial execution of builds. Synchronous in this setting refers to allowing builds to be performed, one after another, after import of the Docker Compose YAML file. Here, this workflow depicts additional operations performed by components used for import and building, specific to the Docker Compose setting.

In the workflow of FIG. 5, the Docker Compose YAML data is imported (e.g., at 502), and the Docker Compose YAML data is parsed and peeled (e.g., at 504). If the Docker Compose content does not include a build tag (e.g., at 506), then the workflow proceeds to generation of the deployment template (e.g., at 508) and deployment/execution of the container images (e.g., at 510).

If the Docker Compose content includes a build tag (e.g., at 506), then operations are performed to extract the block for the build tag, obtain the Git repository details based on offset, and save the imported information (e.g., at 512). This results in updated information to be presented in the dashboard, which can optionally be used to receive build commands and provide updates on completion events (e.g., at 514). For instance, if a request is provided from the build framework (e.g., to build a container), then a build is attempted and information on the build status—success or effort—is tracked (e.g., at 516). In response to a completion event, the build user interface option is replaced with a status message in the dashboard (e.g., at 518). These build operations are repeated for additional build requests (e.g., at 520).

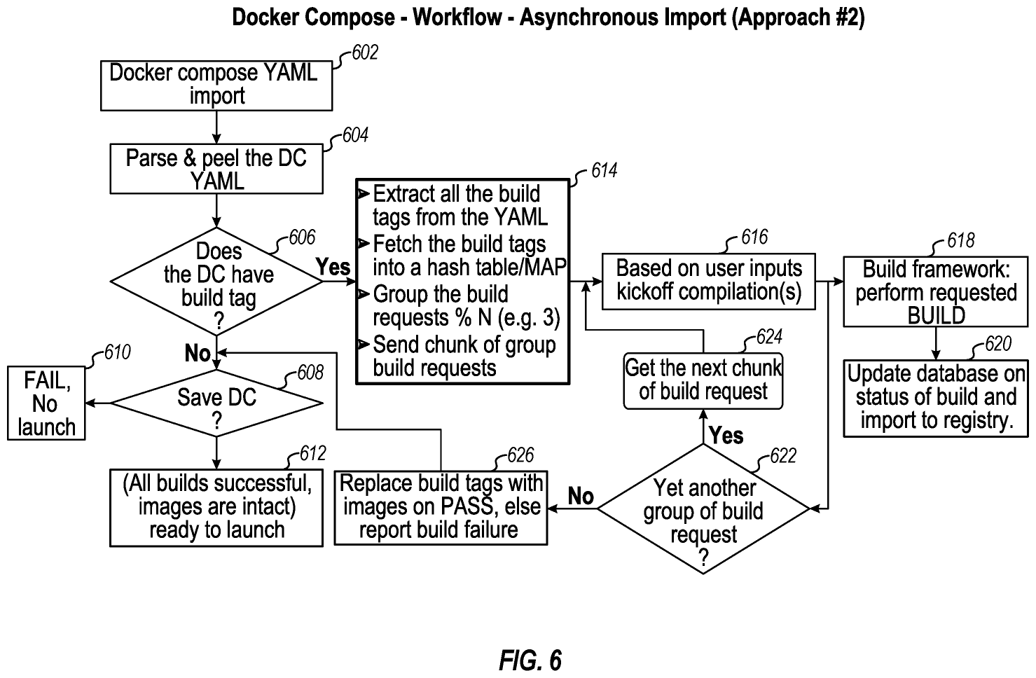

FIG. 6 depicts another approach of an end-to-end flow of a Docker Compose import with asynchronous execution of builds, which uses build requests that kickoff with the build framework asynchronously at the time of import. In the workflow of FIG. 6, the Docker Compose YAML data is imported (e.g., at 602) and the Docker Compose YAML is parsed and peeled (e.g., at 604). If the Docker Compose content does not include a build tag (e.g., at 606), then the workflow proceeds to saving of the Docker Compose content (e.g., at 608). If all builds are successful, then the images are ready to deploy/execute (e.g., at 610). If the builds are not successful, then failure (no launch of the builds) occurs (e.g., at 610). If the builds are successful, then they are ready to launch (e.g., at 612).

If the Docker Compose content includes a build tag (e.g., at 606), then import operations are performed (e.g., at 614) including to: i) extract all of the build tags from the YAML file; ii) fetch the build tags into a hash table or map; iii) group the build requests into N groups (e.g., into 3 requests); and iv) send the chunk of group build requests for further processing. Additionally, user inputs to start compilations (e.g., at 616) may be received. At this point, the build framework can perform the requested build (e.g., at 618), and update a database on the status of build and import to a registry (e.g., at 620).

The operations are repeated based on the identification of other groups of build requests (e.g., at 622) and the processing of the next chunk of the build request (e.g., at 624). When the groups are completed, the build tags are replaced with images (e.g., at 626), and saved as discussed above (e.g., at 610, 612).

Scheduling Framework for Container Orchestration

The following describes additional functionality in an efficient, tunable scheduling framework for execution and container orchestration on the edge across various classes of hardware and accelerators in a CFA. As discussed above, a CFA deployment is designed to run or deploy the containerized workloads coming from a single container application, a group of containers, HELM charts, or Docker Compose YAML(s). Accordingly, a CFA deployment enables end-users to bring in containerized workloads for testing and deployment of, for example, Deep Learning inference (or other types of inference workloads) into a private cloud to run the workload on the edge nodes.

The container orchestrator plays a large role in running any workload on the node in the cluster. Scheduling is the mechanism of the execution framework on any container ecosystem for deployment of workloads. However, the default scheduler that is used by an existing container orchestrator may have various limitations. For instance, the container orchestrator may have a built-in scheduler that assigns the unscheduled pod to a node that best fits, but lacks mechanism to control, manage and report container/pods as demanded in a CFA environment.

The approaches discussed herein provide an optimized CFA scheduling mechanism where the workload execution is managed, controlled, and reported in efficient manner In particular, the following aspects are addressed by the following scheduling solution:

Control: A CFA deployment has a focus on performance of specific Deep Learning workload on the edge and therefore requires a dedicated, specific target type for deployment/execution. When there is large number of deployment requests for a specific type of hardware on the edge with default orchestration scheduling, there can be a flood and high possibility of workload/job loss. This will cause an unpleasant developer/end-user experience. The CFA deployment discussed herein overcomes this issue with the following scheduling/execution framework.

Node availability/Health: In case of the default container orchestration, the scheduler often places the pods (smallest unit of execution) for container workload execution based on best fit node. However, in the CFA deployment discussed herein, the edge nodes need to be assigned based on the selection of processor/accelerator selection for execution of the workload by the end-user. Also, a check on health status of the edge node is necessary condition before execution. This provides a compelling reason to build a framework for running the workload on a specific edge node.

Ordering/Priority: The order/priority in which the workload is kicked off for deployment for a specific node is not managed by the default orchestration scheduler as it largely works based on best fit node based on memory and CPU. The CFA deployment discussed herein aims to address perfect ordering of the workload in a First Come-First Served order for the target hardware without issues.

Retries: Container workloads can fail due to various reasons. In such an event the default orchestration scheduler often will throw an error and does not re-attempt execution. The CFA deployment discussed herein provides scheduling that addresses this issue.

Numbering: While container workloads are provided for execution on the edge nodes, the default orchestration scheduler or framework typically does not provide a mechanism to showcase the position of the workload for execution in the queue. The CFA deployment discussed herein includes scheduling to address this need, as this positioning information can provide useful details to the end-user/developer in observing the progress towards execution.

Time leftover: As the job/workload for execution will wait in the queue for execution, there is no information from the default orchestration scheduler as how much of time is left over for the work run to get kicked off. The CFA deployment discussed herein includes a time feature to address the shortcomings of a default scheduler.

Status: In conventional environments, a granular level state of containers is not maintained by the default orchestration scheduler. The CFA deployment discussed herein includes scheduling to offer various level of state management on workload deployments.

Edge node addition: The CFA deployment discussed herein enables target hardware, on which the workload will run, to be specified by the end-user. Such capabilities are not enabled by a default orchestration scheduler.

Cancellation: In a default orchestration scheduler, once a job is kicked off, there is no provision to cancel it. The CFA deployment discussed herein overcomes this limitation.

The following configuration provides an optimized, self-efficient, easily tunable workload scheduling and execution framework. Specifically, the following configuration aims to provide an optimized scheduling and execution framework with the following features.
1) Flood and control management
2) Edge node readiness and availability management
3) Ordering and numbering management
4) Cancellation and re-try management
5) Timing and status management
6) Edge node management and workload execution

With these features in mind, the overall goal of the following CFA deployment is to provide the developer community with easy, portable, heterogenous solution to validate their Deep Learning models and increase the ease development.

FIG. 7 depicts an example topology of edge nodes for a cloud development environment. In an example, the edge nodes are classified as per the tree depicted here, such as a compute CPU 710 divided into types of processors 720, further divided into generations of the types of processors 730, and further divided into models of the generations of the processors 740. In an example, queues in the distributed queuing system are created based on this tree hierarchy, including where the deployments are tunneled for execution on the specific edge node in a controlled fashion.

In an example, a CFA deployment also adds a scheduling framework on top of the default cluster scheduler. The main function of this scheduling framework is to handle the flood of deployment requests in addition to various other functions.

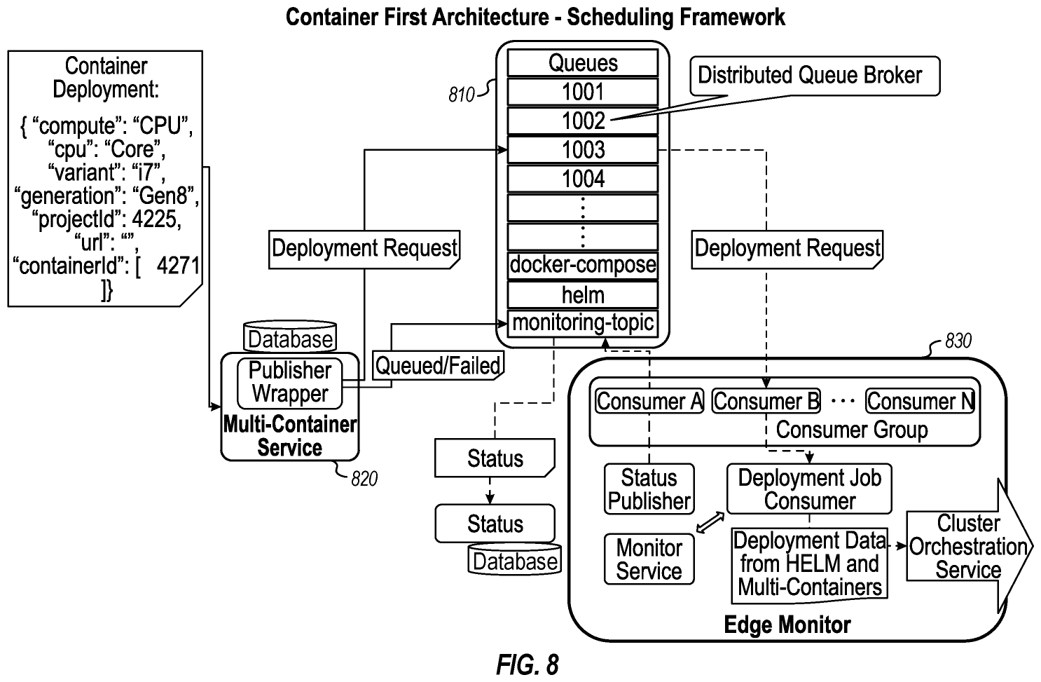

FIG. 8 provides a pictorial representation of an example scheduling framework for a CFA deployment. Deployment requests that come in from the end-users are placed in the distributed queue 810 (e.g., as per the identified classes) based on choice of request. The distributed queue 810 acts as a tunnel to control/barricade the workload executions and push them to cluster for executions based on edge availability and health.

The kind of deployment requests that come from the end-user can be in form of groups of multi-containers, Helm charts or Docker-Compose YAML(s). A high-level design of the flow from user for deployment with these resources includes the following features.

A producer wrapper is integrated inside “Multi-container service” 820 as a JAR dependency, and it exposes a “Deployment Job Handler” for publishing requests to the distributed queue broker. In an example, the deployment request is first validated in the Multi-Container Service based on a Max Deployment Limit (e.g., 3 per user) and a Max Capacity Limit for Queue size (e.g., 20 per Queue). Both parameters are tunable/configurable.

The Edge Monitor 830 contains a Consumer Server which continuously looks for messages on the class of queue for consumption. This is based on availability and health status of the edge node for deployment. The “Deployment Job Consumer” function in the Edge Monitor 830 will compose the deployment request and post it for deployment to the default cluster scheduler via orchestration service. The route response is consumed by a status microservice and saved to database. Granular details of a status can be obtained in either case of deployment resources with respect to pod level and container level, with deployment and comparison identifiers for the given users. Various states of executions can be captured to depict states including queued, scanning, running, deploying, or completed.

Cancellation of jobs is obtained by marking the cancelled job in a database with a flag. When the edge monitor service consumes the job, the job is verified in the database (e.g., whether it is marked as canceled, to skip the deployment). The job is also verified with numbering as the Edge Monitor 830 consumes the job from a queue, and will decrease a count by 1 to be represented in the dashboard for end-user information.

A remaining time left for deployment can be computed based on the assumption that each deployment is given and a wall-time (e.g., of 15 minutes) multiplied by number of entries ahead of the current deployment. While computing this remaining time, the number of available edge nodes is also evaluated.

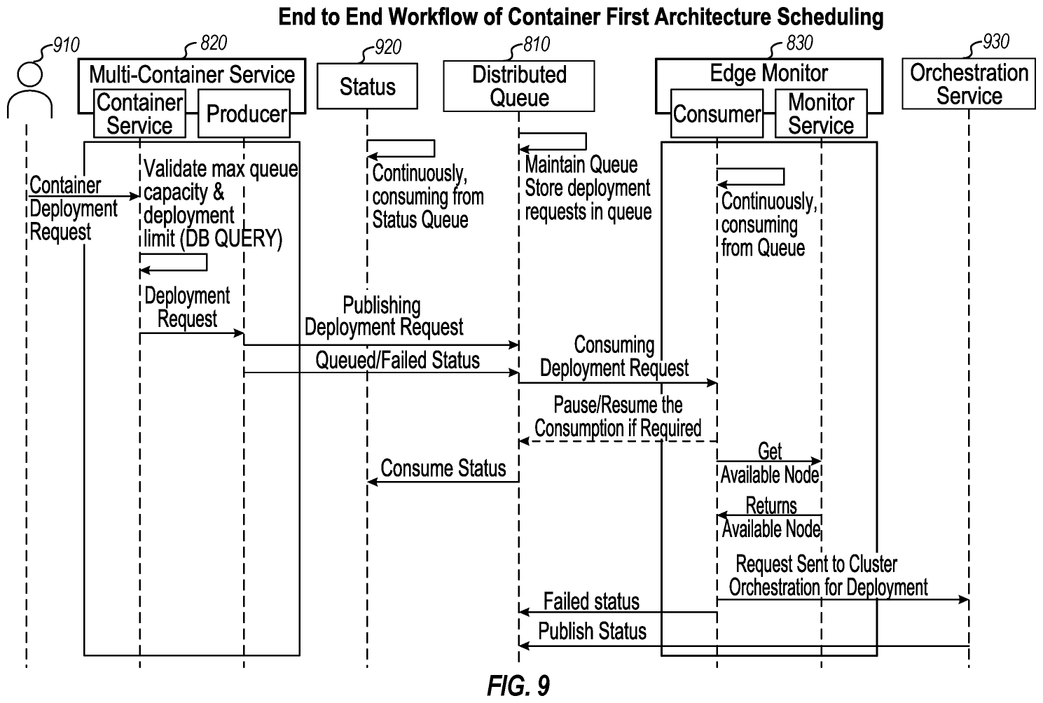

FIG. 9 depicts an end-to-end workflow of scheduling in a CFA deployment. Specifically, this workflow shows how a user 910 may provide a container deployment request to the multi-container service 820, and coordinate execution of different containers based on availability of executing nodes and status of the workload execution in the distributed queue 810.

During the scheduling workflow, a container service and producer of the multi-container service 820 is used to process the container deployment request, validate the maximum capacity and deployment limit, and coordinate the deployment request. The multi-container service 820 provides status 920 for coordination with the distributed queue 810 within the deployment environment. Using the distributed queue 810, an overall status of the deployment environment can be managed by the Edge Monitor 830 and an orchestration service 930.

Additional Techniques for Security and Edge Compliance

In further examples, the various deployments discussed above, whether imported from containers, HELM charts, or Docker compose packages, are further adapted or “mutated” for Security and Edge compliance. With end-users bringing pre-built containers into a development environment in form of container images, HELM charts or Docker Compose YAMLs (e.g., for performance evaluation, deployments, build and test on edge systems), a large challenge that is introduced is security risks. In order to address this, a Container First Architecture (e.g., Container Playground) development platform can safely perform security and edge compliance checks and mutations on the artifacts for the mutual benefit of end-users/developer and platform.

Adaptation of HELM charts and Docker Compose YAMLs may be performed using one or more of the following approaches. First, end-users/developers can import HELM charts or Docker Compose YAMLs from a known set of repositories for deployment across variants of edge hardware on the development platform. For security reasons, the Container Playground framework overrides certain objects and resources in the artifacts in a transparent manner In other words, the HELM chart or Docker Compose YAML data imported by the end-user/developer is subjected to Edge cluster compliance and security compliance before build and deployments. As a result of compliance verification, the container artifacts in packaged formats are migrated towards changes from the platform and are referred to as “Mutating” HELM charts and Docker Compose YAMLs.

Second, replicas can be used for security and edge compliance. Replicas are Kubernetes objects that ensures a stable state of the deployments made across the set of running pods for a given workload on a worker node for High Availability typically useful in production environment. Even though dedicated edge nodes are provided for the end-user/developer on a slotted timeframe (e.g., 30 mins) for every deployment, it is recommended that the replica count is minimal for edge compliance. In an example, the replica count is mutated to a fixed number (e.g., 3) regardless of the values that are included with the artifact. A Denial of DOS attack is prevented in this case to keep the replica at minimum, since the end-user can ask for a certain number of replicas (e.g., 3×times) and load the edge node.

Third, various Linux Capabilities may be evaluated and used to allow binaries (executed by non-root users) to perform privileged operations without providing them all root permissions. Security Context Constraints (SCCs) define privilege and access control settings for a Pod or Container. Essentially SCCs are the tool provided by platform's orchestration layer to control what kind of privileges being requested for each pod is allowed on the platform. For security and edge compliance, the Container Playground may allow end-users/developers with restricted privileges across “ANYUSERID”. This means that privileged containers that expects superuser access should be avoided, if otherwise will be reset to restricted privileges by the platform and in case of absolute need for it will be rejected for deployment. Here, mutation happens, regardless of the type of containers that are imported, whether they are a regular container, sidecar, or “init” containers.

Fourth, roles may be adapted. With advent of role-based access control, superuser privileges are isolated into roles associated with authorized users across privileges of multitude range on need only basis. This means that a network operator is given only a network manager role, and a storage admin is given only a storage manager role. Accordingly, end-user/developers who land on Container Playground are not granted with a cluster manager role (for example) which would improperly enable the user with orchestration management capability. Mutation to remove “ClusterRole” is enabled, so that if the deployment mandates a need for this role, the job will fail.

Fifth, storage may be monitored and adapted. The disk space for every registered user on Container Playground may be granted up to a maximum limit (e.g., of up to 5 GB) for Edge capacity and compliance management. For better utilization of disk space, an option to upload and download files from and into cloud is also made possible via cloud connectors (e.g., connected to remote cloud storage). It is recommended that end-users/developers manage their disk space themselves by cleaning up aged, unwanted, duplicate, or obsolete files and directories. Accordingly, when using HELM charts, may be given a fixed storage quota for import (e.g., 512 MB).

### Example Implementing Methods and Computing Systems

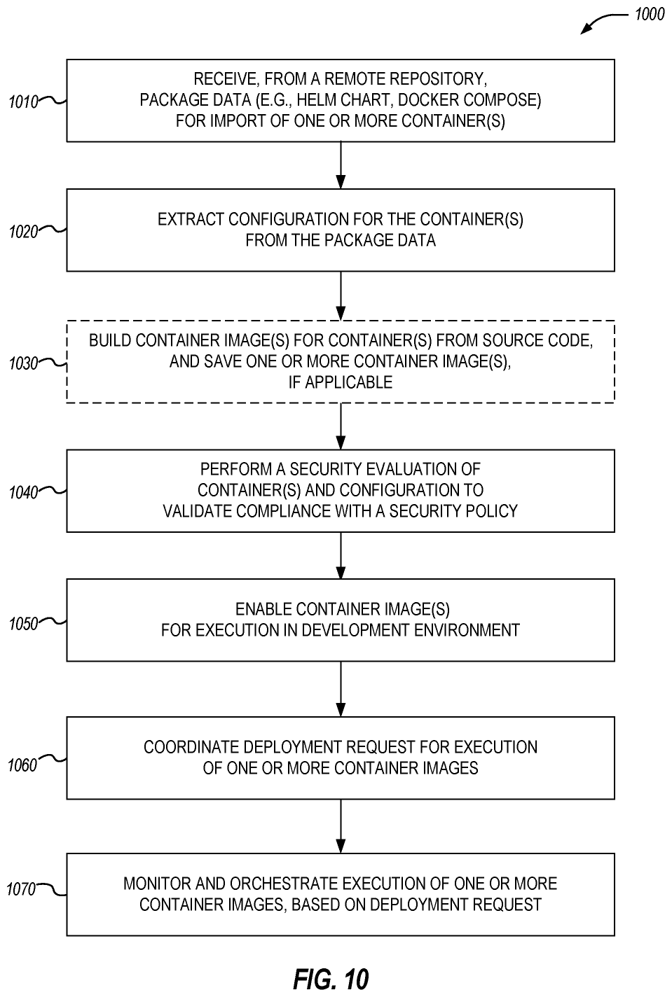

FIG. 10 illustrates a flowchart 1000 for processing of container software package images, encompassing the import and scheduling techniques provided among FIGS. 1 to 9. For instance, the following features of flowchart 1000 may be integrated or adapted with the Helm Chart import operations discussed with reference to FIGS. 1 to 2, the Docker Compose import operations discussed with reference to FIGS. 3 to 6, and the scheduling coordination operations discussed with reference to FIGS. 7 to 9. It will be understood that the processing depicted in flowchart 1000 may be implemented by system or device embodiments (e.g., one or more computing systems or hardware contained thereon), machine-readable manufacture embodiments (e.g., a non-transitory computer-readable medium having instructions to be used by the one or more computing systems or hardware), method embodiments (e.g., a method performed by one or more computing systems or hardware), or the like.

At 1010, operations are performed to receive, from a remote repository, package data (e.g., Helm chart, Docker compose file) for import of one or more container(s). Consistent with the examples discussed herein, in one example, the package data for the one or more containers comprises a Helm chart, and the Helm chart defines one or more application manifests. In another example, the package data for the one or more containers comprises a Docker Compose YAML file.

At 1020, operations are performed to extract the configuration for the one or more containers from the package data. The one or more application manifests of a Helm chart, for instance, may include the configuration that specifies the execution of the one or more container images. Alternately, the Docker Compose YAML file directly includes a configuration to specify the execution of the one or more container images.

At 1030, in a scenario where the package data provides references to source code from a repository, optional operations are performed at the development platform to build container image(s) for container(s) from the source code, and then to save (store) the one or more container image(s) at the development platform. For instance, the source code and the package data may be obtained from a software development project repository (e.g., Git repository).

At 1040, operations are performed to conduct a security evaluation of the one or more containers (and container image(s) that have been built, as applicable). The security evaluation may also validate compliance of a configuration with a security policy. Further, the security evaluation may be performed on one or more resource objects specified by the package data.

At 1050, operations are performed to enable the container image(s) to be executed in the development environment, based on the configuration. This step of enabling may be pre-conditioned on validating compliance with the security policy (at 1040) for the container image, resource objects, and other aspects of the container deployment.

At 1060, operations are performed to coordinate the deployment request for execution of one or more container images. This may occur with the distributed queue and scheduling operations discussed with reference to FIGS. 7 to 9, above.

At 1070, the flowchart concludes with operations to monitor and orchestrate the execution of one or more container images, based on the deployment request. For example, the multi-container service of the development platform may be used to coordinate distribution of the one or more container images and other container images, among a plurality of types of edge computing hardware, based on the distributed queue. As used herein, such edge computing hardware may include the processors or processing platforms discussed with reference to FIG. 7, including lightweight or reduced-power/reduced-resource hardware that is commonly used by edge nodes (e.g., by processing nodes at the edge of a network, rather than high-performance processing nodes in a dedicated data center). Further, the edge monitor of the development platform may be used to monitor the distributed queue and the multi-container service for successful execution of the one or more container images (in addition to other container images).

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method for processing of a container software package for use in a development platform of edge computing hardware, comprising: receiving, at the development platform from a remote location, package data for a deployment of one or more containers, the package data including a configuration for the one or more containers; extracting the configuration for the one or more containers from the package data; performing a security evaluation of the one or more containers and the configuration for the one or more containers, to validate compliance with a security policy of the development platform; and enabling the development platform to conduct execution of one or more container images for the one or more containers based on the configuration, in response to validating compliance with the security policy.

In Example 2, the subject matter of Example 1 optionally includes subject matter where the package data for the one or more containers comprises a Helm chart, wherein the Helm chart defines one or more application manifests, and wherein the one or more application manifests include the configuration to specify the execution of the one or more container images.

In Example 3, the subject matter of any one or more of Examples 1-2 optionally include subject matter where the package data for the one or more containers comprises a Docker Compose YAML file, and wherein the Docker Compose YAML file defines one or more specifications for the execution of the one or more container images.

In Example 4, the subject matter of any one or more of Examples 1-3 optionally include subject matter where the package data for the deployment of the one or more containers provides references to source code from a repository, and wherein the method further comprises: building the one or more container images, at the development platform, from the source code; and storing the one or more container images at the development platform.

In Example 5, the subject matter of Example 4 optionally includes subject matter where the source code and the package data are obtained from a software development project repository.

In Example 6, the subject matter of any one or more of Examples 1-5 optionally include subject matter where the security evaluation is performed on the one or more container images that provide the one or more containers, and wherein the security evaluation is further performed on one or more resource objects specified by the package data.

In Example 7, the subject matter of any one or more of Examples 1-6 optionally include subject matter where the development platform comprises a plurality of types of edge computing hardware available for execution of the one or more containers.

In Example 8, the subject matter of Example 7 optionally includes controlling the execution of the one or more container images at the development platform, wherein the execution includes performance of one or more workloads distributed among a selected set of hardware of the plurality of types of edge computing hardware.

In Example 9, the subject matter of Example 8 optionally includes coordinating a deployment request at the development platform for the execution of the one or more container images, using a distributed queue of the development platform, an edge monitor, and a multi-container service; wherein the multi-container service of the development platform is used to coordinate distribution of the one or more container images and other container images, among the plurality of types of edge computing hardware, based on the distributed queue; and wherein the edge monitor of the development platform is used to monitor the distributed queue and the multi-container service for successful execution of the one or more container images in addition to other container images.

Example 10 is at least one non-transitory machine-readable medium capable of storing instructions for processing of container software packages, wherein the instructions when executed by a computing device of a development platform of edge computing hardware, cause the computing device to perform operations that: receive, at the development platform from a remote location, package data for a deployment of one or more containers, the package data including a configuration for the one or more containers; extract the configuration for the one or more containers from the package data; perform a security evaluation of the one or more containers and the configuration for the one or more containers, to validate compliance with a security policy of the development platform; and enable the development platform to conduct execution of one or more container images for the one or more containers based on the configuration, in response to validating compliance with the security policy.

In Example 11, the subject matter of Example 10 optionally includes subject matter where the package data for the one or more containers comprises a Helm chart, wherein the Helm chart defines one or more application manifests, and wherein the one or more application manifests include the configuration to specify the execution of the one or more container images.

In Example 12, the subject matter of any one or more of Examples 10-11 optionally include subject matter where the package data for the one or more containers comprises a Docker Compose YAML file, and wherein the Docker Compose YAML file defines one or more specifications for the execution of the one or more container images.

In Example 13, the subject matter of any one or more of Examples 10-12 optionally include subject matter where the package data for the deployment of the one or more containers provides references to source code from a repository, and wherein the instructions further cause the computing device to perform operations that: build the one or more container images, at the development platform, from the source code; and store the one or more container images at the development platform.

In Example 14, the subject matter of Example 13 optionally includes subject matter where the source code and the package data are obtained from a software development project repository.

In Example 15, the subject matter of any one or more of Examples 10-14 optionally include subject matter where the security evaluation is performed on the one or more container images that provide the one or more containers, and wherein the security evaluation is further performed on one or more resource objects specified by the package data.

In Example 16, the subject matter of any one or more of Examples 10-optionally include subject matter where the development platform comprises a plurality of types of edge computing hardware available for execution of the one or more containers.

In Example 17, the subject matter of Example 16 optionally includes subject matter where the instructions further cause the computing device to perform operations that: control the execution of the one or more container images at the development platform, wherein the execution includes performance of one or more workloads distributed among a selected set of hardware of the plurality of types of edge computing hardware.

In Example 18, the subject matter of Example 17 optionally includes subject matter where the instructions further cause the computing device to perform operations that: coordinate a deployment request at the development platform for the execution of the one or more container images, using a distributed queue of the development platform, an edge monitor, and a multi-container service; wherein the multi-container service of the development platform is used to coordinate distribution of the one or more container images and other container images, among the plurality of types of edge computing hardware, based on the distributed queue; and wherein the edge monitor of the development platform is used to monitor the distributed queue and the multi-container service for successful execution of the one or more container images in addition to other container images.

Example 19 is a system for processing a container software package for use in a development platform of edge computing hardware, the system comprising: a storage device to store package data for a deployment of one or more containers, the package data including a configuration for the one or more containers; and processing circuitry to: extract the configuration for the one or more containers from the package data; perform a security evaluation of the one or more containers and the configuration for the one or more containers, to validate compliance with a security policy of the development platform; and enable the development platform to conduct execution of one or more container images for the one or more containers based on the configuration, in response to validating compliance with the security policy.

In Example 20, the subject matter of Example 19 optionally includes subject matter where the package data for the one or more containers comprises a Helm chart, wherein the Helm chart defines one or more application manifests, and wherein the one or more application manifests include the configuration to specify the execution of the one or more container images.

In Example 21, the subject matter of any one or more of Examples 19-optionally include subject matter where the package data for the one or more containers comprises a Docker Compose YAML file, and wherein the Docker Compose YAML file defines one or more specifications for the execution of the one or more container images.

In Example 22, the subject matter of any one or more of Examples 19-21 optionally include subject matter where the development platform comprises a plurality of types of edge computing hardware available for execution of the one or more containers, and wherein the processing circuitry is further to: control the execution of the one or more container images at the development platform, wherein the execution includes performance of one or more workloads distributed among a selected set of hardware of the plurality of types of edge computing hardware.

Example 23 is an apparatus for processing of container software package images, for use in an edge computing development platform, the apparatus comprising: means for obtaining, at the development platform from a remote location, package data for a deployment of one or more containers, the package data including a configuration for the one or more containers; means for extracting the configuration for the one or more containers from the package data; means for performing a security evaluation of the one or more containers and the configuration for the one or more containers, to validate compliance with a security policy of the development platform; and means for controlling the development platform to execute one or more container images for the one or more containers based on the configuration, in response to validating compliance with the security policy.

In Example 24, the subject matter of Example 23 optionally includes subject matter where the package data for the one or more containers comprises a Helm chart, wherein the Helm chart defines one or more application manifests, and wherein the one or more application manifests include the configuration to specify the execution of the one or more container images.

In Example 25, the subject matter of any one or more of Examples 23-24 optionally include subject matter where the package data for the one or more containers comprises a Docker Compose YAML file, and wherein the Docker Compose YAML file defines one or more specifications for the execution of the one or more container images.

In Example 26, the subject matter of any of the preceding examples may be extended in operations where a logical segregation of resources (e.g., a Helm chart) can be marked into some placeholder (artifact).

In Example 27, the subject matter of any of the preceding examples may be extended in operations where various Helm resources or artifacts from an end-user can be imported from a Git repository URL or local storage.

In Example 28, the subject matter of any of the preceding examples may be extended in operations where, in processing a Helm chart from a Helm repository, name and security credentials including secrets are processed.

In Example 29, the subject matter of any of the preceding examples may be extended in operations where, a repository name can be allocated to the repository for import.

In Example 30, the subject matter of any of the preceding examples may be extended in operations where, a facility to verify a repository URL is available, and optionally, a master branch is set by default from the repository URL, and further optionally, where one or more Helm Chart from the repository is retrieved or downloaded.

In Example 31, the subject matter of any of the preceding examples may be extended in operations where, inspection of a Helm Chart occurs on the fly to perform checks on cluster compliance, followed by approval or rejection of the same.

In Example 32, the subject matter of any of the preceding examples may be extended in operations where, a Helm Chart is processed as is or converted to a required format for deployment.

In Example 33, the subject matter of any of the preceding examples may be extended in operations where, Helm Chart values are overridden in Values.yaml for cluster security compliance.

In Example 34, the subject matter of any of the preceding examples may be extended in operations where, security integrity checks are performed on the resource objects that are part of the Helm Chart.

In Example 35, the subject matter of any of the preceding examples may be extended in operations where, the Helm Chart repositories are constantly update at certain intervals.

In Example 36, the subject matter of any of the preceding examples may be extended in operations where, the security is honored based on clustering edge boundaries.

In Example 37, the subject matter of any of the preceding examples may be extended in operations where, container images in the Helm Charts are peeled out by inspection to verify each resource.

In Example 38, the subject matter of any of the preceding examples may be extended in operations where, cluster security policies are validated across the Helm Chart for execution, and optionally, where Helm Chart resources are overridden for compliance to cluster security policies.

In Example 39, the subject matter of any of the preceding examples may be extended in operations where original and revised Helm Charts are presented to the end-user for comparison.

In Example 40, the subject matter of any of the preceding examples may be extended in operations where an end-user is warned of breaching the cluster security policy on import of Helm Chart.

In Example 41, the subject matter of any of the preceding examples may be extended in operations where, an imported Helm Chart is ready to launch only if all security compliances are successful.

In Example 42, the subject matter of any of the preceding examples may be extended in operations where a Helm Chart is imported in a cluster without security boundaries as privileged user, and optionally, where no security overrides happen.

In Example 43, the subject matter of any of the preceding examples may be extended in operations where a Helm Chart is executed on variants of hardware, and optionally, the results of execution are stored in a persistent local storage or a physical volume, and further optionally, the results thus generated are viewable after a container execution.

In Example 44, the subject matter of any of the preceding examples may be extended in operations where inspection of a Helm Chart for potential import and deployment can be performed via a cluster compliance verification API or tool, and optionally, where a correction mechanism is suggested to the user based on cluster compliance checks and verifications.

In Example 45, the subject matter of any of the preceding examples may be extended in operations where dynamic storage volumes are created for storing intermediate execution results during deployment.

In Example 46, the subject matter of any of the preceding examples may be extended in operations in which containers in the HELM charts can be accessed from inside of a container shell for debugging purposes.

In Example 47, the subject matter of any of the preceding examples may be extended in operations where logs for individual containers are available from a project dashboard.

In Example 48, the subject matter of any of the preceding examples may be extended in operations by which multiple deployments of Helm Charts, Docker Compose files, or containers from the projects can be kicked-off simultaneously for deployments across variants of edge hardware.

In Example 49, the subject matter of any of the preceding examples may be extended in operations where Docker Compose YAML from an end-user is imported into the platform.

In Example 50, the subject matter of any of the preceding examples may be extended in operations in which the Docker Compose repository, name and security credentials including secrets are processed.

In Example 51, the subject matter of any of the preceding examples may be extended in operations where validity of the Docker Compose YAML happens on the fly.

In Example 52, the subject matter of any of the preceding examples may be extended in operations in which the repository is downloaded or processed as is.

In Example 53, the subject matter of any of the preceding examples may be extended in operations where the Docker Compose YAML file is processed as is, or converted to a required format, for processing.

In Example 54, the subject matter of any of the preceding examples may be extended in operations where security integrity checks are performed on the resources that are part of the Docker Compose YAML file, and optionally, where the security is honored based on cluster or edge boundaries.

In Example 55, the subject matter of any of the preceding examples may be extended in operations where, the Docker Compose YAML is parsed to fetch the location details on pre-built containers.

In Example 56, the subject matter of any of the preceding examples may be extended in operations in which container images in the Docker Compose YAML are peeled out by inspection to fetch build tags one by one, and optionally, by which a source list is obtained, and further optionally, by which the build tags thus obtained are subjected to compilation for generation of container images.

In Example 57, the subject matter of any of the preceding examples may be extended in operations where created container images are pushed into a cluster's internal registry, and a build tag section in the template is replaced with this information accordingly after successful completion of the build.

In Example 58, the subject matter of any of the preceding examples may be extended in operations by which nested build requests are made from an innermost source path.

In Example 59, the subject matter of any of the preceding examples may be extended in operations by which a Dockerfile in the Docker Compose YAML is built directly.

In Example 60, the subject matter of any of the preceding examples may be extended in operations where source code in the relative path is downloaded and built, or by which sources are directly built.

In Example 61, the subject matter of any of the preceding examples may be extended in operations where repository (e.g., Git) branch details are sought, and optionally, by which a master branch is set by default.

In Example 62, the subject matter of any of the preceding examples may be extended in operations where a programming language (PL) and version of compiler is sought for a build of a container image.

In Example 63, the subject matter of any of the preceding examples may be extended in operations by which programming language (PL) and version of compiler to be used for a build of a container image is automatically detected.

In Example 64, the subject matter of any of the preceding examples may be extended in operations by which a build can be provided in a batch request.

In Example 65, the subject matter of any of the preceding examples may be extended in operations by which a build can occur in a chunk of a bulk request made by order of “N”, where “N is numeric.

In Example 66, the subject matter of any of the preceding examples may be extended in operations by which a build can occur in a build request that made in silos.

In Example 67, the subject matter of any of the preceding examples may be extended in operations by which a build can occur in a build request from which all the sources can be made.

In Example 68, the subject matter of any of the preceding examples may be extended in operations by which cluster security policies are validated across the Docker Compose YAML for execution, and optionally, by which Docker Compose YAML resources are overridden for compliance to cluster security policies.

In Example 69, the subject matter of any of the preceding examples may be extended in operations by which original and revised Docker Compose YAML are presented to the end-user for comparison.

In Example 70, the subject matter of any of the preceding examples may be extended in operations by which an end-user is warned of breaching the cluster security policy on import of Docker Compose YAML.

In Example 71, the subject matter of any of the preceding examples may be extended in operations by which the Docker Compose YAML is imported synchronously. (e.g., builds occur after import of Docker Compose YAML).

In Example 72, the subject matter of any of the preceding examples may be extended in operations by which the Docker Compose YAML is imported asynchronously. (e.g., builds are kicked off during import of Docker Compose YAML itself).

In Example 73, the subject matter of any of the preceding examples may be extended in operations by which the imported Docker Compose YAML is ready to launch only if all builds are successful.

In Example 74, the subject matter of any of the preceding examples may be extended in operations by which the Docker Compose YAML is imported in a cluster without security boundaries as privileged user, and optionally, by which no security overrides happen.

In Example 75, the subject matter of any of the preceding examples may be extended in operations by which Docker Compose YAML is executed on variants of hardware.

In Example 76, the subject matter of any of the preceding examples may be extended in operations by which the results of execution are stored in persistent local storage or physical volume, and optionally, by which the results thus generated are viewable after container execution.

In Example 77, the subject matter of any of the preceding examples may be extended in operations by which Docker Compose volumes are obtained from relative paths prior to execution.

In Example 78, the subject matter of any of the preceding examples may be extended in operations by which deployments from containers, HELM charts and Docker compose are mutated or adapted for Security and Edge computing compliance.

In Example 79, the subject matter of any of the preceding examples may be extended in operations where deployments in form of Docker Compose YAML, HELM charts, or Multi-Container images are kicked off on the edge computing hardware across multiple hardware variants.

In Example 80, the subject matter of any of the preceding examples may be extended in operations where a framework comprises a mechanism to classify edge or cluster nodes for hardware selection and execution based on user choice for containerized workloads.

In Example 81, the subject matter of any of the preceding examples may be extended in operations by which a flood (large number) of job requests is controlled.

In Example 82, the subject matter of any of the preceding examples may be extended in operations by which an edge node already classified is flexible for expansion, on the fly, based on the need for an addition or removal of hardware.

In Example 83, the subject matter of any of the preceding examples may be extended in operations by which the container deployments are provided to the classified nodes on the cluster per user choice of hardware selection.

In Example 84, the subject matter of any of the preceding examples may be extended in operations by which the container deployments are pushed to a node in a cluster based on one or more of: availability, health, or affinity.

In Example 85, the subject matter of any of the preceding examples may be extended in operations by which the container deployments operate with a First In First Out order.

In Example 86, the subject matter of any of the preceding examples may be extended in operations by which container deployments are performed in a priority of deployment from a user persona.

In Example 87, the subject matter of any of the preceding examples may be extended in operations by which a re-attempt of container deployments is automatically performed or scheduled, in event of failure, for another time.

In Example 88, the subject matter of any of the preceding examples may be extended in operations by which a queue number for deployment on specific hardware is shown or tracked.

In Example 89, the subject matter of any of the preceding examples may be extended in operations by which an amount of time is left for a container deployment to be kicked off on a specific edge node of desired hardware type.

In Example 90, the subject matter of any of the preceding examples may be extended in operations by which cancellation of a container deployment or job is allowed after it is initiated for deployment.

In Example 91, the subject matter of any of the preceding examples may be extended in operations by which statuses of container deployments are shown to the user with granularity at a change of every state.

In Example 92, the subject matter of any of the preceding examples may be extended in operations by which data that is generated as result of workload execution is provided in particular formats.

In Example 93, the subject matter of any of the preceding examples may be extended in operations by which deployments from containers, Helm charts and Docker compose are verified for Security and Edge compliance.

In Example 94, the subject matter of any of the preceding examples may be extended in operations by which deployments from containers, Helm charts and Docker compose are mutated or adapted for Security and Edge compliance, using replicas, using roles, or using storage management techniques.

Example 95 is at least one machine-readable medium including instructions that, when executed by processing circuitry, cause the processing circuitry to perform operations to implement of any of Examples 1-94.

Example 96 is an apparatus comprising means to implement of any of Examples 1-94.

Example 97 is a system to implement of any of Examples 1-94.

Example 98 is a method to implement of any of Examples 1-94.

### Example Edge Computing Architectures

Although the previous discussion was provided with reference to specific networked compute deployments, it will be understood that the build, testing, or deployment instances may be implemented at any number of devices that access services from the “cloud”, devices that access services from the “edge cloud”, or devices that access services from the “data center cloud”.

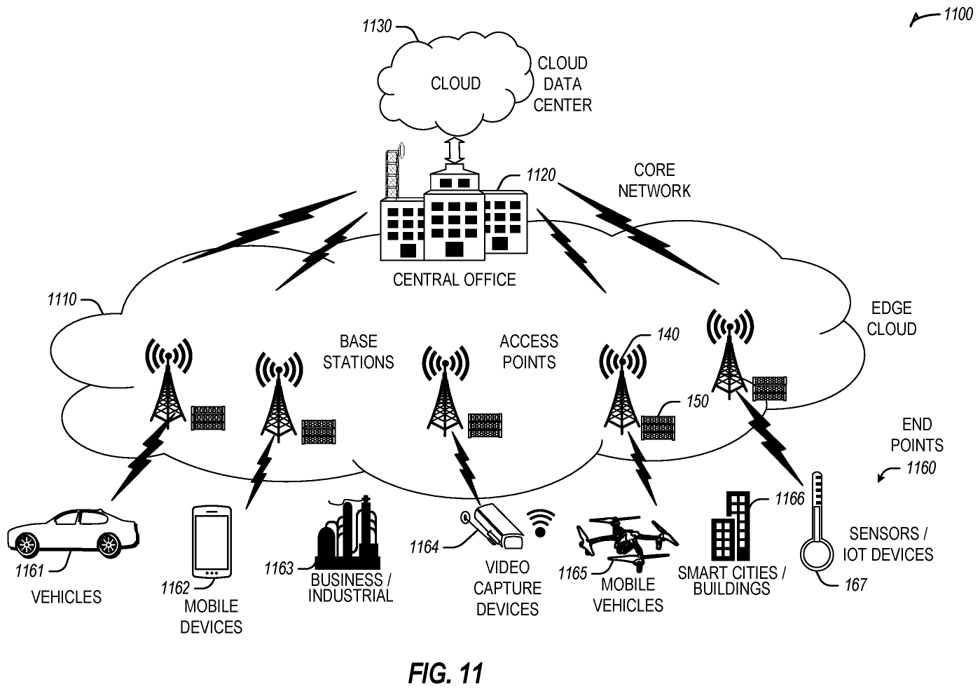

FIG. 11 is a block diagram 1100 showing an overview of a configuration for edge computing, which includes a layer of processing referenced in many of the current examples as an “edge cloud”. As shown, the edge cloud 1110 is co-located at an edge location, such as an access point or base station 1140, a local processing hub 1150, or a central office 1120, and thus may include multiple entities, devices, and equipment instances. The edge cloud 1110 is located much closer to the endpoint (consumer and producer) data sources 1160 (e.g., autonomous vehicles 1161, user equipment 1162, business and industrial equipment 1163, video capture devices 1164, mobile vehicles (e.g., drones) 1165, smart cities and building devices 1166, sensors and IoT devices 1167, etc.) than the cloud data center 1130. Compute, memory, and storage resources which are offered at the edges in the edge cloud 1110 are critical to providing ultra-low latency response times for services and functions used by the endpoint data sources 1160 as well as reduce network backhaul traffic from the edge cloud 1110 toward cloud data center 1130 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 11, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data-center.

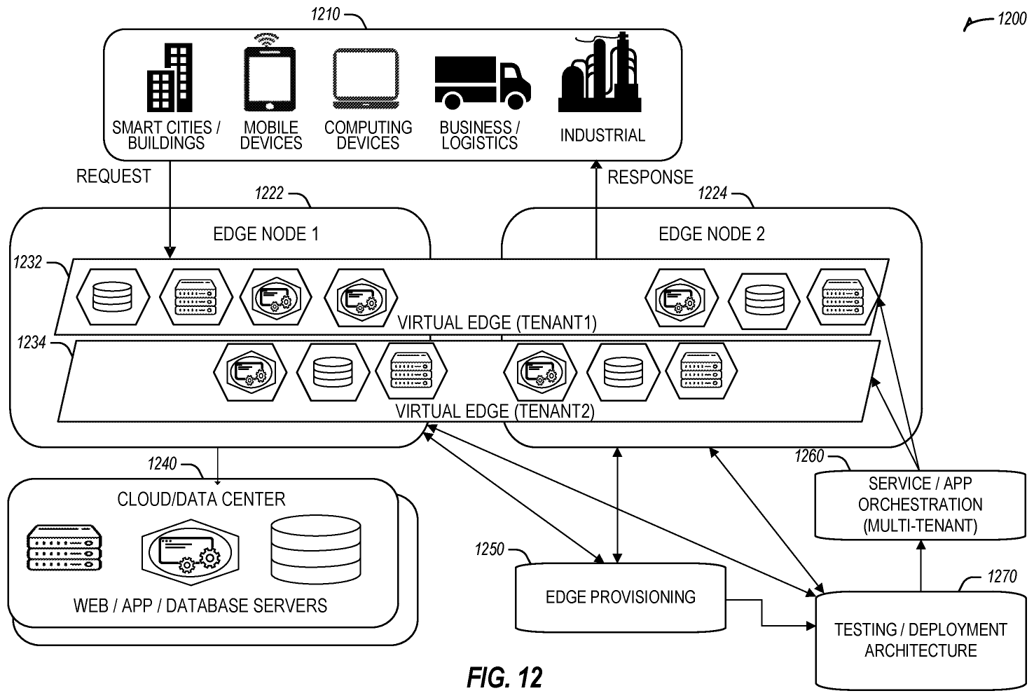

FIG. 12 illustrates deployment and orchestration for virtual edge configurations across an edge computing system operated among multiple edge nodes and multiple tenants. Specifically, FIG. 12 depicts coordination of a first edge node 1222 and a second edge node 1224 in an edge computing system 1200, to fulfill requests and responses for various client endpoints 1210 (e.g., smart cities/building systems, mobile devices, computing devices, business/logistics systems, industrial systems, etc.), which access various virtual edge instances. The virtual edge instances 1232, 1234 (or virtual edges) provide edge compute capabilities and processing in an edge cloud, with access to a cloud/data center 1240 for higher-latency requests for websites, applications, database servers, etc. Thus, the edge cloud enables coordination of processing among multiple edge nodes for multiple tenants or entities.

In the example of FIG. 12, these virtual edge instances include a first virtual edge 1232, offered to a first tenant (Tenant 1), which offers a first combination of edge storage, computing, and services; and a second virtual edge 1234, offering a second combination of edge storage, computing, and services, to a second tenant (Tenant 2). The virtual edge instances 1232, 1234 are distributed among the edge nodes 1222, 1224, and may include scenarios in which a request and response are fulfilled from the same or different edge nodes. The configuration of each edge node 1222, 1224 to operate in a distributed yet coordinated fashion occurs based on edge provisioning functions 1250. The functionality of the edge nodes 1222, 1224 to provide coordinated operation for applications and services, among multiple tenants, occurs based on orchestration functions 1260.

It should be understood that some of the devices in 1210 are multi-tenant devices where Tenant1 may function within a Tenant1 ‘slice’ while a Tenant2 may function within a Tenant2 ‘slice’ (and, in further examples, additional or sub-tenants may exist; and each tenant may even be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A RoT may further be computed dynamically composed using a compute security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 1210, 1222, and 1240 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other compute security functions related to the provisioning and lifecycle of the trusted ‘slice’ concept in FIG. 12. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or, respective computing systems and resources which are co-owned or co-managed by multiple owners).

For instance, each edge node 1222, 1224 may implement the use of containers, such as with the use of a container “pod” 1226, 1228 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 1232, 1234 are partitioned according to the needs of each container.

With the use of container pods, a pod controller oversees the partitioning and allocation of containers and resources. The pod controller receives instructions from an orchestrator (e.g., performing orchestration functions 1260) that instructs the controller on how to appropriately partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a compute security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator 1260 may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute, and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to each tenant (aside from the execution of virtualized network functions).

Within the edge cloud, a first edge node 1222 (e.g., operated by a first owner) and a second edge node 1224 (e.g., operated by a second owner) may operate or respond to a container orchestrator to coordinate the execution of various applications within the virtual edge instances offered for respective tenants. For instance, the edge nodes 1222, 1224 may be coordinated based on edge provisioning functions 1250, while the operation of the various applications is coordinated with orchestration functions 1260.

Various system arrangements may provide an architecture that treats VMs, Containers, and Functions equally in terms of application composition (and resulting applications are combinations of these three ingredients). Each ingredient may involve the use of one or more accelerator (e.g., FPGA, ASIC) components as a local backend. In this manner, applications can be split across multiple edge owners, coordinated by an orchestrator.

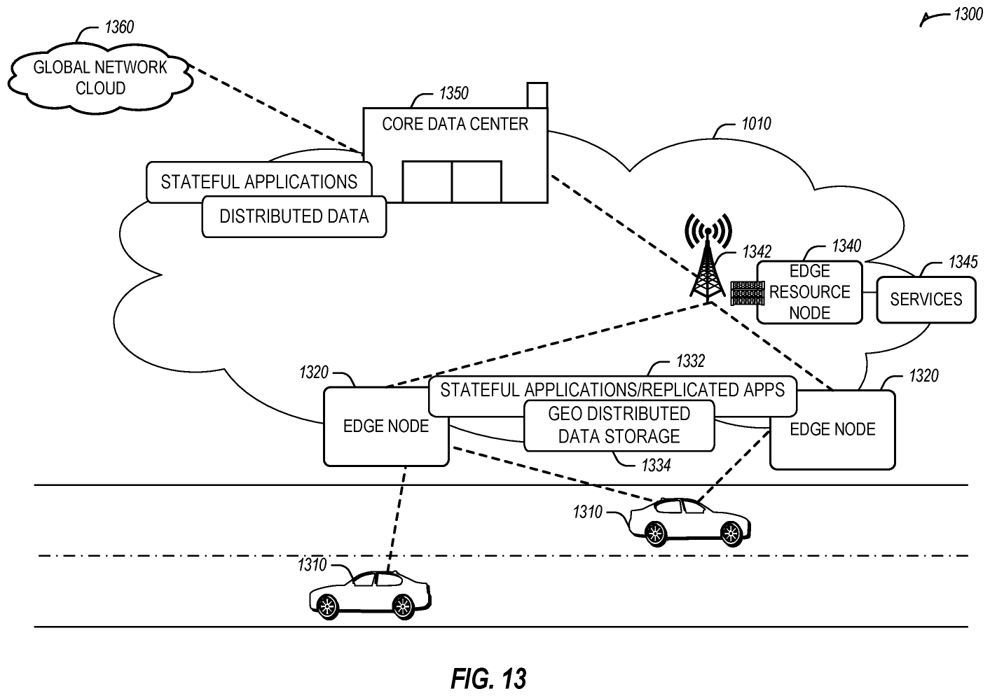

It should be appreciated that the edge computing systems and arrangements discussed herein may be applicable in various solutions, services, and/or use cases. As an example, FIG. 13 shows a simplified vehicle compute and communication use case involving mobile access to applications in an edge computing system 1300 that implements an edge cloud 1110 connected to service instances 1345. In this use case, each client compute node 1310 may be embodied as in-vehicle compute systems (e.g., in-vehicle navigation and/or infotainment systems) located in corresponding vehicles that communicate with the edge gateway nodes 1320 during traversal of a roadway. For instance, edge gateway nodes 1320 may be located in roadside cabinets, which may be placed along the roadway, at intersections of the roadway, or other locations near the roadway. As each vehicle traverses along the roadway, the connection between its client compute node 1310 and a particular edge gateway node 1320 may propagate to maintain a consistent connection and context for the client compute node 1310. Each of the edge gateway nodes 1320 includes some processing and storage capabilities and, as such, some processing and/or storage of data for the client compute nodes 1310 may be performed on one or more of the edge gateway nodes 1320.

Each of the edge gateway nodes 1320 may communicate with one or more edge resource nodes 1340, which are illustratively embodied as compute servers, appliances or components located at or in a communication base station 1342 (e.g., a base station of a cellular network). As discussed above, each edge resource node 1340 includes some processing and storage capabilities, and, as such, some processing and/or storage of data for the client compute nodes 1310 may be performed on the edge resource node 1340. For example, the processing of data that is less urgent or important may be performed by the edge resource node 1340, while the processing of data that is of a higher urgency or importance may be performed by edge gateway devices or the client nodes themselves (depending on, for example, the capabilities of each component). Further, various wired or wireless communication links (e.g., fiber optic wired backhaul, 5G wireless links) may exist among the edge nodes 1320, edge resource node(s) 1340, core data center 1350, and network cloud 1360.

The edge resource node(s) 1340 also communicate with the core data center 1350, which may include compute servers, appliances, and/or other components located in a central location (e.g., a central office of a cellular communication network). The core data center 1350 may provide a gateway to the global network cloud 1360 (e.g., the Internet) for the edge cloud 1110 operations formed by the edge resource node(s) 1340 and the edge gateway nodes 1320. Additionally, in some examples, the core data center 1350 may include an amount of processing and storage capabilities and, as such, some processing and/or storage of data for the client compute devices may be performed on the core data center 1350 (e.g., processing of low urgency or importance, or high complexity). The edge gateway nodes 1320 or the edge resource nodes 1340 may offer the use of stateful applications 1332 and a geographically distributed data storage 1334 (e.g., database, data store, etc.).

In further examples, FIG. 13 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 1320, some others at the edge resource node 1340, and others in the core data center 1350 or the global network cloud 1360.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

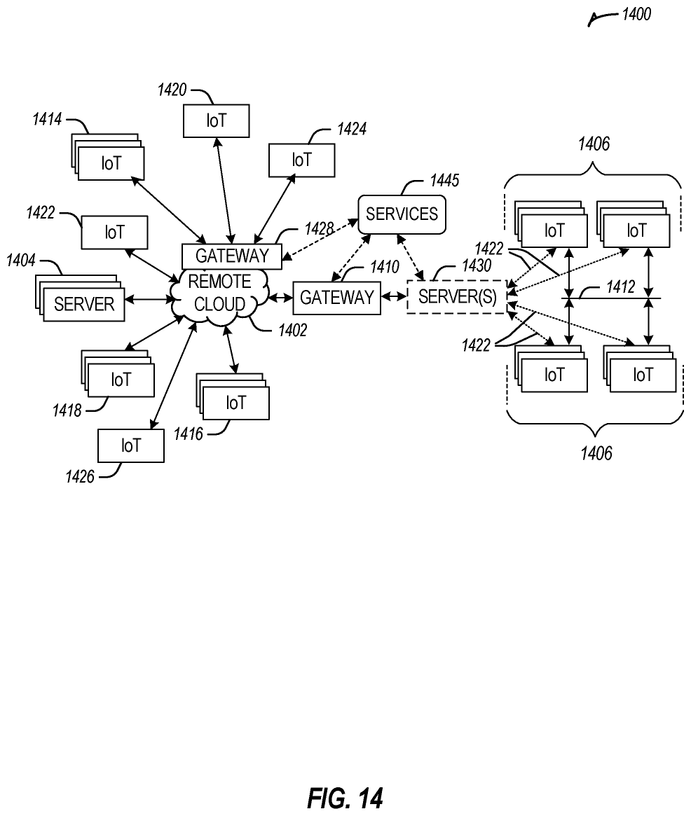

As a more detailed illustration of an Internet of Things (IoT) network, FIG. 14 illustrates a drawing of a cloud or edge computing network 1400, in communication with several IoT devices and a container development and execution services 1445. The IoT is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 14, the network 1400 may represent portions of the Internet or may include portions of a local area network (LAN), or a wide area network (WAN), such as a proprietary network for a company. The IoT devices may include any number of different types of devices, grouped in various combinations. For example, a traffic control group 1406 may include IoT devices along streets in a city. These IoT devices may include stoplights, traffic flow monitors, cameras, weather sensors, and the like. The traffic control group 1406, or other subgroups, may be in communication within the network 1400 through wired or wireless links 1408, such as LPWA links, optical links, and the like. Further, a wired or wireless sub-network 1412 may allow the IoT devices to communicate with each other, such as through a local area network, a wireless local area network, and the like. The IoT devices may use another device, such as a gateway 1410 or 1428 to communicate with remote locations such as remote cloud 1402; the IoT devices may also use one or more servers 1430 to facilitate communication within the network 1400 or with the gateway 1410. For example, the one or more servers 1430 may operate as an intermediate network node to support a local edge cloud or fog implementation among a local area network. Further, the gateway 1428 that is depicted may operate in a cloud-to-gateway-to-many edge devices configuration, such as with the various IoT devices 1414, 1420, 1424 being constrained or dynamic to an assignment and use of resources in the network 1400.

In an example embodiment, the network 1400 can further include or be communicatively coupled to a service instance or deployment configured to perform deployment or service operations within the network 1400, such as that discussed above.

Other example groups of IoT devices may include remote weather stations 1414, local information terminals 1416, alarm systems 1418, automated teller machines 1420, alarm panels 1422, or moving vehicles, such as emergency vehicles 1424 or other vehicles 1426, among many others. Each of these IoT devices may be in communication with other IoT devices, with servers 1404, with another IoT device or system, another edge computing or “fog” computing system, or a combination therein. The groups of IoT devices may be deployed in various residential, commercial, and industrial settings (including in both private or public environments).

As may be seen from FIG. 14, a large number of IoT devices may be communicating through the network 1400. This may allow different IoT devices to request or provide information to other devices autonomously. For example, a group of IoT devices (e.g., the traffic control group 1406) may request a current weather forecast from a group of remote weather stations 1414, which may provide the forecast without human intervention. Further, an emergency vehicle 1424 may be alerted by an automated teller machine 1420 that a burglary is in progress. As the emergency vehicle 1424 proceeds towards the automated teller machine 1420, it may access the traffic control group 1406 to request clearance to the location, for example, by lights turning red to block cross traffic at an intersection in sufficient time for the emergency vehicle 1424 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 1414 or the traffic control group 1406, may be equipped to communicate with other IoT devices as well as with the network 1400. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPv6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QoS) based swarming and coordination/combinations of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource-based trust and service indices may be inserted to improve the data integrity, quality, assurance, and deliver a metric of data confidence.

### Example Computing Devices

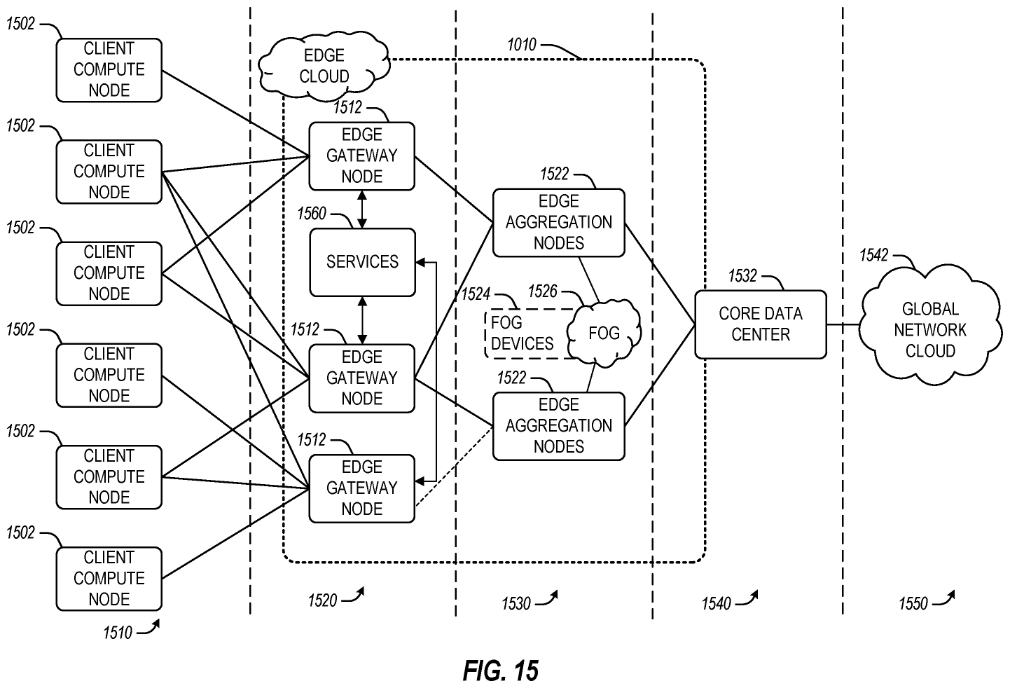

At a more generic level, an edge computing system may be described to encompass any number of deployments operating in the edge cloud 1110, which provide coordination from client and distributed computing devices. FIG. 15 provides a further abstracted overview of layers of distributed compute deployed among an edge computing environment for purposes of illustration.

FIG. 15 generically depicts an edge computing system for providing edge services and applications to multi-stakeholder entities, as distributed among one or more client compute nodes 1502, one or more edge gateway nodes 1512, one or more edge aggregation nodes 1522, one or more core data centers 1532, and a global network cloud 1542, as distributed across layers of the network. The implementation of the edge computing system may be provided at or on behalf of a telecommunication service provider (“telco”, or “TSP”), internet-of-things service provider, a cloud service provider (CSP), enterprise entity, or any other number of entities. Various forms of wired or wireless connections may be configured to establish connectivity among the nodes 1502, 1512, 1522, 1532, including interconnections among such nodes (e.g., connections among edge gateway nodes 1512, and connections among edge aggregation nodes 1522). Such connectivity and federation of these nodes may be assisted with the use of container development and execution services 1560 and service instances, as discussed herein.

Each node or device of the edge computing system is located at a particular layer corresponding to layers 1510, 1520, 1530, 1540, and 1550. For example, the client compute nodes 1502 are each located at an endpoint layer 1510, while each of the edge gateway nodes 1512 is located at an edge devices layer 1520 (local level) of the edge computing system. Additionally, each of the edge aggregation nodes 1522 (and/or fog devices 1524, if arranged or operated with or among a fog networking configuration 1526) is located at a network access layer 1530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 1532 is located at a core network layer 1540 (e.g., a regional or geographically-central level), while the global network cloud 1542 is located at a cloud data center layer 1550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 1532 may be located within, at, or near the edge cloud 1110.

Although an illustrative number of client compute nodes 1502, edge gateway nodes 1512, edge aggregation nodes 1522, core data centers 1532, and global network clouds 1542 are shown in FIG. 15, it should be appreciated that the edge computing system may include more or fewer devices or systems at each layer. Additionally, as shown in FIG. 15, the number of components of each layer 1510, 1520, 1530, 1540, and 1550 generally increases at each lower level (i.e., when moving closer to endpoints). As such, one edge gateway node 1512 may service multiple client compute nodes 1502, and one edge aggregation node 1522 may service multiple edge gateway nodes 1512.

Consistent with the examples provided herein, each client compute node 1502 may be embodied as any type of end point component, device, appliance, or “thing” capable of communicating as a producer or consumer of data. Further, the label “node” or “device” as used in the edge computing system 1500 does not necessarily mean that such node or device operates in a client or minion/follower/agent role; rather, any of the nodes or devices in the edge computing system 1500 refer to individual entities, nodes, or subsystems which include discrete or connected hardware or software configurations to facilitate or use the edge cloud 1110.

As such, the edge cloud 1110 is formed from network components and functional features operated by and within the edge gateway nodes 1512 and the edge aggregation nodes 1522 of layers 1520, 1530, respectively. The edge cloud 1110 may be embodied as any type of network that provides edge computing and/or storage resources which are proximately located to radio access network (RAN) capable endpoint devices (e.g., mobile computing devices, IoT devices, smart devices, etc.), which are shown in FIG. 15 as the client compute nodes 1502. In other words, the edge cloud 1110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1110 may form a portion of or otherwise provide an ingress point into or across a fog networking configuration 1526 (e.g., a network of fog devices 1524, not shown in detail), which may be embodied as a system-level horizontal and distributed architecture that distributes resources and services to perform a specific function. For instance, a coordinated and distributed network of fog devices 1524 may perform computing, storage, control, or networking aspects in the context of an IoT system arrangement. Other networked, aggregated, and distributed functions may exist in the edge cloud 1110 between the cloud data center layer 1550 and the client endpoints (e.g., client compute nodes 1502). Some of these are discussed in the following sections in the context of network functions or service virtualization, including the use of virtual edges and virtual services which are orchestrated for multiple stakeholders.

The edge gateway nodes 1512 and the edge aggregation nodes 1522 cooperate to provide various edge services and compute security features to the client compute nodes 1502. Furthermore, because each client compute node 1502 may be stationary or mobile, each edge gateway node 1512 may cooperate with other edge gateway devices to propagate presently provided edge services and compute security features as the corresponding client compute node 1502 moves about a region. To do so, each of the edge gateway nodes 1512 and/or edge aggregation nodes 1522 may support multiple tenancies and multiple stakeholder configurations, in which services from (or hosted for) multiple service providers and multiple consumers may be supported and coordinated across a single or multiple compute devices.

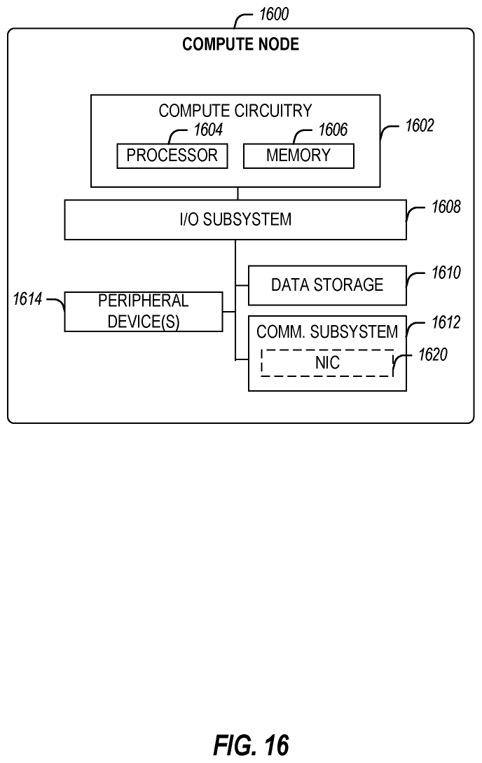

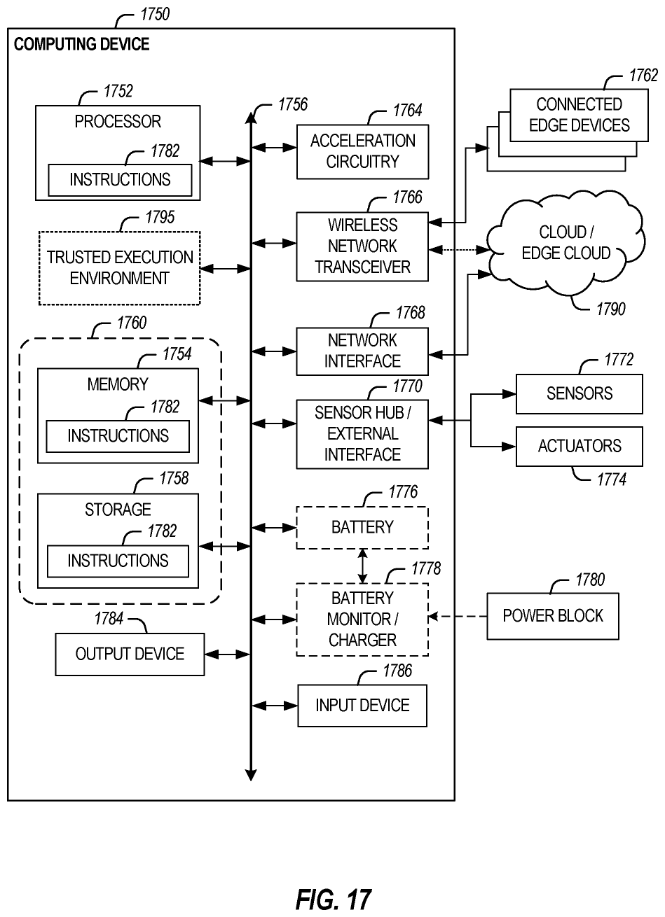

In further examples, any of the compute nodes or devices discussed with reference to the present edge computing systems and environment may be fulfilled based on the components depicted in FIGS. 16 and 17. Each edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 16, an edge compute node 1600 includes a compute engine (also referred to herein as “compute circuitry”) 1602, an input/output (I/O) subsystem 1608, data storage 1610, a communication circuitry subsystem 1612, and, optionally, one or more peripheral devices 1614. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1600 may be embodied as any type of engine, device, or collection of devices capable of performing various compute functions. In some examples, the compute node 1600 may be embodied as a single device such as an integrated circuit, an embedded system, a field-programmable gate array (FPGA), a system-on-a-chip (SOC), or other integrated system or device. In the illustrative example, the compute node 1600 includes or is embodied as a processor 1604 and a memory 1606. The processor 1604 may be embodied as any type of processor capable of performing the functions described herein (e.g., executing an application). For example, the processor 1604 may be embodied as a multi-core processor(s), a microcontroller, a processing unit, a specialized or special purpose processing unit, or other processor or processing/controlling circuit. In some examples, the processor 1604 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 1604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), dedicated compute circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized compute units such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, a SOC, a CPU, and other variations of the processor 1604 may work in coordination with each other to execute many types of operations and instructions within and on behalf of the compute node 1600.

The main memory 1606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 1606 may be integrated into the processor 1604. The main memory 1606 may store various software and data used during operation such as one or more applications, data operated on by the application(s), libraries, and drivers.

The compute circuitry 1602 is communicatively coupled to other components of the compute node 1600 via the I/O subsystem 1608, which may be embodied as circuitry and/or components to facilitate input/output operations with the compute circuitry 1602 (e.g., with the processor 1604 and/or the main memory 1606) and other components of the compute circuitry 1602. For example, the I/O subsystem 1608 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1608 may form a portion of a system-on-a-chip (SoC) and be incorporated, along with one or more of the processor 1604, the main memory 1606, and other components of the compute circuitry 1602, into the compute circuitry 1602.

The one or more illustrative data storage devices 1610 may be embodied as any type of device configured for short-term or long-term storage of data such as, for example, memory devices and circuits, memory cards, hard disk drives, solid-state drives, or other data storage devices. Each data storage device 1610 may include a system partition that stores data and firmware code for the data storage device 1610. Each data storage device 1610 may also include one or more operating system partitions that store data files and executables for operating systems depending on, for example, the type of compute node 1600.

The communication circuitry 1612 may be embodied as any communication circuit, device, or collection thereof, capable of enabling communications over a network between the compute circuitry 1602 and another compute device (e.g., an edge gateway node 1512 of the edge computing system 1500). The communication circuitry 1612 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 1612 includes a network interface controller (NIC) 1620, which may also be referred to as a host fabric interface (HFI). The NIC 1620 may be embodied as one or more add-in-boards, daughter cards, network interface cards, controller chips, chipsets, or other devices that may be used by the compute node 1600 to connect with another compute device (e.g., an edge gateway node 1512). In some examples, the NIC 1620 may be embodied as part of a system-on-a-chip (SoC) that includes one or more processors or included on a multichip package that also contains one or more processors. In some examples, the NIC 1620 may include a local processor (not shown) and/or a local memory and storage (not shown) that are local to the NIC 1620. In such examples, the local processor of the NIC 1620 (which can include general-purpose accelerators or specific accelerators) may be capable of performing one or more of the functions of the compute circuitry 1602 described herein. Additionally, or alternatively, the local memory of the NIC 1620 may be integrated into one or more components of the client compute node at the board level, socket level, chip level, and/or other levels.

Additionally, in some examples, each compute node 1600 may include one or more peripheral devices 1614. Such peripheral devices 1614 may include any type of peripheral device found in a compute device or server such as audio input devices, a display, other input/output devices, interface devices, and/or other peripheral devices, depending on the particular type of the compute node 1600. In further examples, the compute node 1600 may be embodied by a respective edge compute node in an edge computing system (e.g., client compute node 1502, edge gateway node 1512, edge aggregation node 1522) or like forms of appliances, computers, subsystems, circuitry, or other components.

In a more detailed example, FIG. 17 illustrates a block diagram of an example of components that may be present in an edge computing device (or node) 1750 for implementing the techniques (e.g., operations, processes, methods, and methodologies) described herein. The edge computing node 1750 provides a closer view of the respective components of node 1600 when implemented as or as part of a computing device (e.g., as a mobile device, a base station, server, gateway, etc.). The edge computing node 1750 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 1750, or as components otherwise incorporated within a chassis of a larger system.

The edge computing node 1750 may include processing circuitry in the form of a processor 1752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1752 may be a part of a system on a chip (SoC) in which the processor 1752 and other components are formed into a single integrated circuit, or a single package, such as the Edison™ or Galileo™ SoC boards from Intel Corporation, Santa Clara, California. As an example, the processor 1752 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 1752 and accompanying circuitry may be provided in a single socket form factor, multiple socket form factor, or a variety of other formats, including in limited hardware configurations or configurations that include fewer than all elements shown in FIG. 17.

The processor 1752 may communicate with a system memory 1754 over an interconnect 1756 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 1758 may also couple to the processor 1752 via the interconnect 1756. In an example, the storage 1758 may be implemented via a solid-state disk drive (SSDD). Other devices that may be used for the storage 1758 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 1758 may be on-die memory or registers associated with the processor 1752. However, in some examples, the storage 1758 may be implemented using a micro hard disk drive (HDD) or solid-state drive (SSD). Further, any number of new technologies may be used for the storage 1758 in addition to, or instead of, the technologies described, such resistance change memories, phase change memories, holographic memories, or chemical memories, among others.

The components may communicate over the interconnect 1756. The interconnect 1756 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 1756 may be a proprietary bus, for example, used in an SoC based system. Other bus systems may be included, such as an I2C interface, an SPI interface, point to point interfaces, and a power bus, among others.

The interconnect 1756 may couple the processor 1752 to a transceiver 1766, for communications with the connected edge devices 1762. The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the edge computing node 1750 may communicate with close devices, e.g., within about 10 meters, using a local transceiver based on BLE, or another low power radio, to save power. More distant connected edge devices 1762, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 1766 (e.g., a radio transceiver) may be included to communicate with devices or services in the edge cloud 1790 via local or wide area network protocols. The wireless network transceiver 1766 may be an LPWA transceiver that follows the IEEE 802.15.4, or IEEE 802.15.4g standards, among others. The edge computing node 1750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1768 may be included to provide a wired communication to nodes of the edge cloud 1790 or other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components 1764, 1766, 1768, or 1770. Accordingly, in various examples, applicable means for communicating (e.g., receiving, transmitting, etc.) may be embodied by such communications circuitry.

The edge computing node 1750 may include or be coupled to acceleration circuitry 1764, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1756 may couple the processor 1752 to a sensor hub or external interface 1770 that is used to connect additional devices or subsystems. The devices may include sensors 1772, such as accelerometers, level sensors, flow sensors, optical light sensors, camera sensors, temperature sensors, a global navigation system (e.g., GPS) sensors, pressure sensors, barometric pressure sensors, and the like. The hub or interface 1770 further may be used to connect the edge computing node 1750 to actuators 1774, such as power switches, valve actuators, an audible sound generator, a visual warning device, and the like.

In some optional examples, various input/output (I/O) devices may be present within or connected to, the edge computing node 1750. For example, a display or other output device 1784 may be included to show information, such as sensor readings or actuator position. An input device 1786, such as a touch screen or keypad may be included to accept input. An output device 1784 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1776 may power the edge computing node 1750, although, in examples in which the edge computing node 1750 is mounted in a fixed location, it may have a power supply coupled to an electrical grid, or the battery may be used as a backup or for temporary capabilities. The battery 1776 may be a lithium-ion battery, or a metal-air battery, such as a zinc-air battery, an aluminum-air battery, a lithium-air battery, and the like.

A battery monitor/charger 1778 may be included in the edge computing node 1750 to track the state of charge (SoCh) of the battery 1776. The battery monitor/charger 1778 may be used to monitor other parameters of the battery 1776 to provide failure predictions, such as the state of health (SoH) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1778 may communicate the information on the battery 1776 to the processor 1752 over the interconnect 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the edge computing node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the edge computing node 1750. A wireless battery charging circuit, such as an LTC4020 chip from Linear Technologies of Milpitas, California, among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1782 in the form of software, firmware, or hardware commands to implement the techniques described herein. Although such instructions 1782 are shown as code blocks included in the memory 1754 and the storage 1758, it may be understood that any of the code blocks may be replaced with hardwired circuits, for example, built into an application-specific integrated circuit (ASIC).

Also in a specific example, the instructions 1782 on the processor 1752 (separately, or in combination with the instructions 1782 of the machine readable medium 1760) may configure execution or operation of a trusted execution environment (TEE) 1795. In an example, the TEE 1795 operates as a protected area accessible to the processor 1752 for secure execution of instructions and secure access to data. Various implementations of the TEE 1795, and an accompanying secure area in the processor 1752 or the memory 1754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 1750 through the TEE 1795 and the processor 1752.

In an example, the instructions 1782 provided via memory 1754, the storage 1758, or the processor 1752 may be embodied as a non-transitory, machine-readable medium 1760 including code to direct the processor 1752 to perform electronic operations in the edge computing node 1750. The processor 1752 may access the non-transitory, machine-readable medium 1760 over the interconnect 1756. For instance, the non-transitory, machine-readable medium 1760 may be embodied by devices described for the storage 1758 or may include specific storage units such as optical disks, flash drives, or any number of other hardware devices. The non-transitory, machine-readable medium 1760 may include instructions to direct the processor 1752 to perform a specific sequence or flow of actions, for example, as described with respect to the flowchart(s) and block diagram(s) of operations and functionality depicted above. As used herein, the terms “machine-readable medium”, “computer-readable medium”, “machine-readable storage”, and “computer-readable storage” are interchangeable.

In an example embodiment, the edge computing node 1750 can be implemented using components/modules/blocks 1752-1786 which are configured as IP Blocks. Each IP Block may contain a hardware RoT (e.g., device identifier composition engine, or DICE), where a DICE key may be used to identify and attest the IP Block firmware to a peer IP Block or remotely to one or more of components/modules/blocks 1762-1780. Thus, it will be understood that the node 1750 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 16 and 17 is intended to depict a high-level view of components of a device, subsystem, or arrangement of an edge computing node. However, it will be understood that some of the components shown may be omitted, additional components may be present, and a different arrangement of the components shown may occur in other implementations.

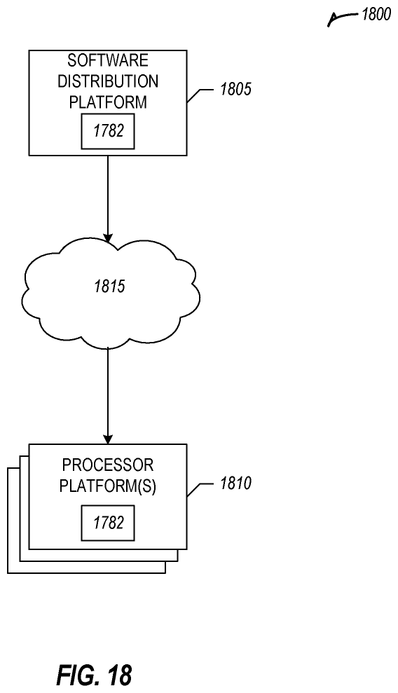

FIG. 18 illustrates an example software distribution platform 1805 to distribute software, such as the example computer readable instructions 1782 of FIG. 17, to one or more devices, such as example processor platform(s) 1810 and/or other example connected edge devices or systems discussed herein. The example software distribution platform 1805 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1805). Example connected edge devices may operate in commercial and/or home automation environments. In some examples, a third party is a developer, a seller, and/or a licensor of software such as the example computer readable instructions 1782 of FIG. 17. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 18, the software distribution platform 1805 includes one or more servers and one or more storage devices that store the computer readable instructions 1782. The one or more servers of the example software distribution platform 1805 are in communication with a network 1815, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1782 from the software distribution platform 1805. For example, the software, which may correspond to example computer readable instructions, may be downloaded to the example processor platform(s), which is/are to execute the computer readable instructions 1782. In some examples, one or more servers of the software distribution platform 1805 are communicatively connected to one or more security domains and/or security devices through which requests and transmissions of the example computer readable instructions 1782 must pass. In some examples, one or more servers of the software distribution platform 1805 periodically offer, transmit, and/or force updates to the software (e.g., the example computer readable instructions 1782 of FIG. 17) to ensure improvements, patches, updates, etc. are distributed and applied to the software at the end user devices.

In the illustrated example of FIG. 18, the computer readable instructions 1782 are stored on storage devices of the software distribution platform 1805 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 1782 stored in the software distribution platform 1805 are in a first format when transmitted to the example processor platform(s) 1810. In some examples, the first format is an executable binary in which particular types of the processor platform(s) 1810 can execute. However, in some examples, the first format is uncompiled code that requires one or more preparation tasks to transform the first format to a second format to enable execution on the example processor platform(s) 1810. For instance, the receiving processor platform(s) 1800 may need to compile the computer readable instructions 1782 in the first format to generate executable code in a second format that is capable of being executed on the processor platform(s) 1710. In still other examples, the first format is interpreted code that, upon reaching the processor platform(s) 1810, is interpreted by an interpreter to facilitate execution of instructions.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

1. A method for processing of a container software package for use in a development platform of edge computing hardware, comprising:
receiving, at the development platform from a remote location, package data for a deployment of one or more containers, the package data including a configuration for the one or more containers;
extracting the configuration for the one or more containers from the package data;
performing a security evaluation of the one or more containers and the configuration for the one or more containers, to validate compliance with a security policy of the development platform; and
enabling the development platform to conduct execution of one or more container images for the one or more containers based on the configuration, in response to validating compliance with the security policy.

2. The method of claim 1, wherein the package data for the one or more containers comprises a Helm chart, wherein the Helm chart defines one or more application manifests, and wherein the one or more application manifests include the configuration to specify the execution of the one or more container images.

3. The method of claim 1, wherein the package data for the one or more containers comprises a Docker Compose YAML file, and wherein the Docker Compose YAML file includes the configuration to specify the execution of the one or more container images.

4. The method of claim 1, wherein the package data for the deployment of the one or more containers provides references to source code from a repository, and wherein the method further comprises:
building the one or more container images, at the development platform, from the source code; and
storing the one or more container images at the development platform.

5. The method of claim 4, wherein the source code and the package data are obtained from a software development project repository.

6. The method of claim 1, wherein the security evaluation is performed on the one or more container images that provide the one or more containers, and wherein the security evaluation is further performed on one or more resource objects specified by the package data.

7. The method of claim 1, wherein the development platform comprises a plurality of types of edge computing hardware available for execution of the one or more containers.

8. The method of claim 7, further comprising:
controlling the execution of the one or more container images at the development platform, wherein the execution includes performance of one or more workloads distributed among a selected set of hardware of the plurality of types of edge computing hardware.

9. The method of claim 8, further comprising:
coordinating a deployment request at the development platform for the execution of the one or more container images, using a distributed queue of the development platform, an edge monitor, and a multi-container service;
wherein the multi-container service of the development platform is used to coordinate distribution of the one or more container images and other container images, among the plurality of types of edge computing hardware, based on the distributed queue; and
wherein the edge monitor of the development platform is used to monitor the distributed queue and the multi-container service for successful execution of the one or more container images in addition to other container images.

10. At least one non-transitory machine-readable medium capable of storing instructions for processing of container software packages, wherein the instructions when executed by a computing device of a development platform of edge computing hardware, cause the computing device to perform operations that:
receive, at the development platform from a remote location, package data for a deployment of one or more containers, the package data including a configuration for the one or more containers;
extract the configuration for the one or more containers from the package data;
perform a security evaluation of the one or more containers and the configuration for the one or more containers, to validate compliance with a security policy of the development platform; and
enable the development platform to conduct execution of one or more container images for the one or more containers based on the configuration, in response to validating compliance with the security policy.

11. The machine-readable medium of claim 10, wherein the package data for the one or more containers comprises a Helm chart, wherein the Helm chart defines one or more application manifests, and wherein the one or more application manifests include the configuration to specify the execution of the one or more container images.

12. The machine-readable medium of claim 10, wherein the package data for the one or more containers comprises a Docker Compose YAML file, and wherein the Docker Compose YAML file defines one or more specifications for the execution of the one or more container images.

13. The machine-readable medium of claim 10, wherein the package data for the deployment of the one or more containers provides references to source code from a repository, and wherein the instructions further cause the computing device to perform operations that:
build the one or more container images, at the development platform, from the source code; and
store the one or more container images at the development platform.

14. The machine-readable medium of claim 13, wherein the source code and the package data are obtained from a software development project repository.

15. The machine-readable medium of claim 10, wherein the security evaluation is performed on the one or more container images that provide the one or more containers, and wherein the security evaluation is further performed on one or more resource objects specified by the package data.

16. The machine-readable medium of claim 10, wherein the development platform comprises a plurality of types of edge computing hardware available for execution of the one or more containers.

17. The machine-readable medium of claim 16, wherein the instructions further cause the computing device to perform operations that:
control the execution of the one or more container images at the development platform, wherein the execution includes performance of one or more workloads distributed among a selected set of hardware of the plurality of types of edge computing hardware.

18. The machine-readable medium of claim 17, wherein the instructions further cause the computing device to perform operations that:
coordinate a deployment request at the development platform for the execution of the one or more container images, using a distributed queue of the development platform, an edge monitor, and a multi-container service;
wherein the multi-container service of the development platform is used to coordinate distribution of the one or more container images and other container images, among the plurality of types of edge computing hardware, based on the distributed queue; and
wherein the edge monitor of the development platform is used to monitor the distributed queue and the multi-container service for successful execution of the one or more container images in addition to other container images.

19. A system for processing a container software package for use in a development platform of edge computing hardware, the system comprising:
a storage device to store package data for a deployment of one or more containers, the package data including a configuration for the one or more containers; and
processing circuitry to:
extract the configuration for the one or more containers from the package data;
perform a security evaluation of the one or more containers and the configuration for the one or more containers, to validate compliance with a security policy of the development platform; and
enable the development platform to conduct execution of one or more container images for the one or more containers based on the configuration, in response to validating compliance with the security policy.

20. The system of claim 19, wherein the package data for the one or more containers comprises a Helm chart, wherein the Helm chart defines one or more application manifests, and wherein the one or more application manifests include the configuration to specify the execution of the one or more container images.

21. The system of claim 19, wherein the package data for the one or more containers comprises a Docker Compose YAML file, and wherein the Docker Compose YAML file defines one or more specifications for the execution of the one or more container images.

22. The system of claim 19, wherein the development platform comprises a plurality of types of edge computing hardware available for execution of the one or more containers, and wherein the processing circuitry is further to:
control the execution of the one or more container images at the development platform, wherein the execution includes performance of one or more workloads distributed among a selected set of hardware of the plurality of types of edge computing hardware.

23. An apparatus for processing of container software package images, for use in an edge computing development platform, the apparatus comprising:
means for obtaining, at the development platform from a remote location, package data for a deployment of one or more containers, the package data including a configuration for the one or more containers;
means for extracting the configuration for the one or more containers from the package data;
means for performing a security evaluation of the one or more containers and the configuration for the one or more containers, to validate compliance with a security policy of the development platform; and
means for controlling the development platform to execute one or more container images for the one or more containers based on the configuration, in response to validating compliance with the security policy.

24. The apparatus of claim 23, wherein the package data for the one or more containers comprises a Helm chart, wherein the Helm chart defines one or more application manifests, and wherein the one or more application manifests include the configuration to specify the execution of the one or more container images.

25. The apparatus of claim 23, wherein the package data for the one or more containers comprises a Docker Compose YAML file, and wherein the Docker Compose YAML file defines one or more specifications for the execution of the one or more container images.
